(19) United States
(12) Patent Application Publication
(10) Pub. No.: US 2025/0238389 A1
(43) Pub. Date: Jul. 24, 2025

(54) LINK TELEMETRY REPORTING

(71) Applicant: Kandou Labs SA, Saint-Sulpice (CH)

(72) Inventors: Alexander Koch, Hamm (DE); Jayarama Shenoy, San Jose, CA (US); Subhash Roy, Lexington, MA (US)

(21) Appl. No.: 19/030,541

(22) Filed: Jan. 17, 2025

Related U.S. Application Data
(60) Provisional application No. 63/622,337, filed on Jan. 18, 2024.

(51) Int. Cl. G06F 13/42

(52) U.S. Cl. CPC G06F 13/4221; G06F 2213/0026

(57) ABSTRACT

Methods and systems are described for receiving, at an upstream-facing pseudo-port of a retimer, a telemetry request command via one or more control skip-ordered sets (C-SKPs), the telemetry request command including one of a plurality of telemetry IDs respectively identifying types of telemetry data, the types of telemetry data selected from the group consisting of: retimer training and status state machine (RTSSM) state information and temperature data, retrieving telemetry data from the retimer associated with the telemetry ID in the telemetry request command, receiving, at a downstream-facing pseudo-port of the retimer, C-SKPs, and responsively generating modified C-SKPs by rewriting fields of the received C-SKPs with the retrieved telemetry data, and transmitting the modified C-SKPs via the upstream-facing pseudo-port.

### CROSS-REFERENCE TO RELATED APPLICATION

This application claims the benefit of U.S. Provisional Application No. 63/622,337, filed Jan. 18, 2024, entitled “Link Telemetry Reporting”, naming Alexander Koch, Jayarama Shenoy, and Subhash Roy, which is hereby incorporated by reference in its entirety for all purposes.

### REFERENCES

The following references are herein incorporated by reference in their entirety for all purposes:

PCT Application No. PCT/US 23/79339 filed Nov. 10, 2023, naming Alexander Koch, entitled “Retimer Training and Status State Machine Synchronization Across Multiple Integrated Circuit Dies”, herein [Koch].

PCT Application No. PCT/US23/78924 filed Nov. 7, 2023, naming Subhash Roy, Peter Korger, Alexander Koch and Jon Nicoll, entitled “In-Band Data Package Transmission”, herein [Roy].

### BACKGROUND

Various protocols exist for communicating between different components of a system via a communication link. A common feature of most protocols is that they include a link setup phase in which data is gathered about the communication medium, e.g., a wire in the case of wireline communication or a radio frequency environment in the case of wireless communication. Properties of the link may be set during the link setup phase based on this information gathered about the link and/or based on components communicating via the link, e.g., a root complex and/or endpoint in the case of a PCIe link.

Some protocols provide the option to recalibrate an existing link, perhaps periodically or in response to some state of the link being entered indicating that recalibration is necessary. Data relating to the link can be referred to as link telemetry and the process of gathering information about a link and reporting this information may be called metrology.

In some scenarios it is necessary to include one or more retimers in a communication link in order to ensure that quality-related parameters like bit error rate are met over the entire link. A retimer receives an incoming signal and conditions the signal such that an outgoing signal from the retimer is ‘cleaner’, e.g., it has reduced skew and/or reduced jitter relative to the incoming signal. The data carried by the signal itself is typically unchanged by a retimer. For this reason, a retimer is usually fully transparent to devices communicating via the link. The presence of a retimer splits a link into multiple portions; each portion may have different link telemetry.

Data centers support business applications through e.g, data storage (management, backup, recovery), productivity applications, e-commerce transactions, online gaming, and machine learning/artificial intelligence (AI) based applications. FIG. 1 is a diagram of a data center containing multiple server racks. As shown, the server racks are spaced such that the hot air flows between the backs of adjacent server racks while the cold air flows between the fronts of adjacent server racks. The server racks may contain many rack-mounted chassis that contain motherboards, switch cards, and the like. The motherboards are interconnected by cables. Further, the various boards within a given chassis may be interconnected by e.g., mini cool edge (MCIO) cables.

### BRIEF DESCRIPTION

Methods and systems are described for receiving, at an upstream-facing pseudo-port of a retimer, a telemetry request command via one or more control skip-ordered sets (C-SKPs), the telemetry request command including one of a plurality of telemetry IDs respectively identifying types of telemetry data, the types of telemetry data selected from the group consisting of: retimer training and status state machine (RTSSM) state information and temperature data, retrieving telemetry data from the retimer associated with the telemetry ID in the telemetry request command, receiving, at a downstream-facing pseudo-port of the retimer, C-SKPs, and responsively generating modified C-SKPs by rewriting fields of the received C-SKPs with the retrieved telemetry data, and transmitting the modified C-SKPs via the upstream-facing pseudo-port.

### BRIEF DESCRIPTION OF THE DRAWINGS

FIG. 1 is a block diagram of a board comprising a retimer coupled to a board management controller (BMC), in accordance with some embodiments.

FIG. 2 is a block diagram of a retimer circuit die, in accordance with some embodiments.

FIG. 3A is a block diagram of a two-die retimer with a first link configuration, in accordance with some embodiments.

FIG. 3B is a block diagram of a two-die retimer with a second link configuration, in accordance with some embodiments.

FIG. 4 is a block diagram of a multi-chip module (MCM) including multiple retimer circuit dies configured to exchange state information, in accordance with some embodiments.

FIG. 5 is a diagram of a data center, in accordance with some embodiments.

FIG. 6 illustrates an environment of two server racks interconnected by cables, in accordance with some embodiments.

FIG. 7 is a block diagram of two server racks coupled by a passive cable, in accordance with some embodiments.

FIG. 8A illustrates a control skip ordered set (C-SKP).

FIG. 8B is a block diagram of a telemetry request sequence and a telemetry response sequence transported using C-SKPs, in accordance with some embodiments.

FIG. 9 illustrates a more detailed view of a link between two endpoints on different boards interconnected by an active cable, in accordance with some embodiments.

FIG. 10 is a top-down view of a server rack illustrating placement of the retimer module on the side of the chassis, in accordance with some embodiments.

FIG. 11 is a block diagram of a host and an endpoint on separate boards interconnected by mini cool edge (MCIO) cables interconnected by a retimer module, in accordance with some embodiments.

FIG. 12 is a block diagram of a retimer module, in accordance with some embodiments.

FIG. 13 is a pinout diagram of a MCIO cable.

### DETAILED DESCRIPTION

Some parts of this specification describe the operation of link telemetry-gathering techniques in the context of a collection of rack-mounted servers that are located in respective racks and communicate via one or more cables coupling the respective racks together. This is sometimes known as a ‘data center’. This is a particular environment in which embodiments of this disclosure have utility. However, this disclosure is not limited to this environment as embodiments find utility in any scenario where a link is (conceptually) divided into multiple portions, where a BMC or other such controlling entity does not have direct access (e.g. via a system management bus or similar) to all portions of the link.

Embodiments are described in connection with the PCIe protocol, meaning that reference to a ‘link’ implies PCIe link unless expressly stated otherwise. However, this is not to be understood as limiting as the techniques disclosed herein can be applied to other protocols.

Data centers include multiple server racks that contain many types of printed circuit boards (PCBs) including, but not limited to, central processing unit (CPU) motherboards, graphics processing unit (GPU) motherboards, Input/Output (I/O) boards, and Peripheral Component Interconnect Express (PCIe) switch card boards for e.g., GPUs. Components on PCBs and between PCBs are often connected via MCIO cables which extend PCIe signal paths while maintaining signal integrity (SI) performance compared to conventional PCB routing methods. MCIO connector placements on printed circuit boards (PCBs) are often optimized for trace length on motherboards and PCIe switch boards, and thus often there is no space in the chassis for inserting retimer interposer boards.

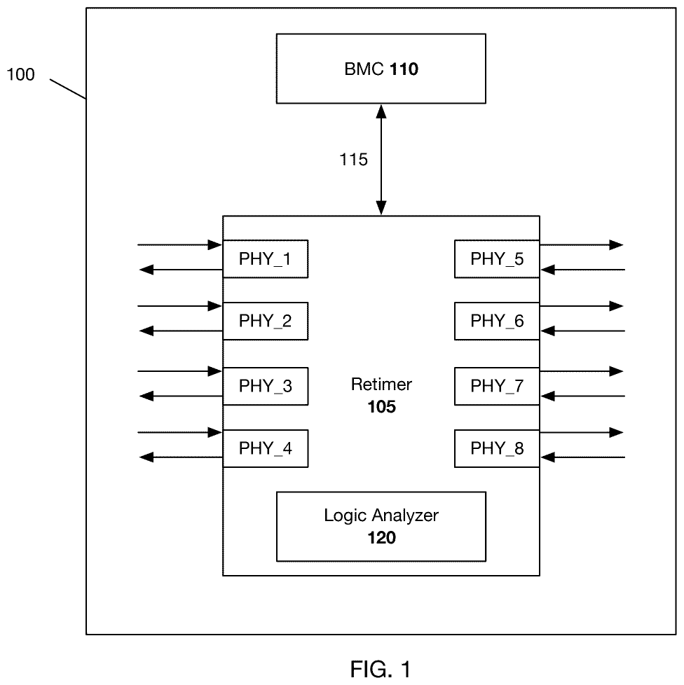

FIG. 1 is a block diagram of a board 100 comprising a retimer 105 and a board management controller (BMC) 110. BMC 110 functions to monitor the status of components on board 100 including retimer 105. The BMC can gather information about the components and report this information to an external entity (i.e. outside board 100) that has responsibility for managing board 100. In the context of a data center, the external entity can be a data center administrator or administrative platform that has responsibility for managing a number of boards like board 100. Retimer 105 can be a Peripheral Component Interconnect express (PCIe) retimer configured to participate in one or more PCIe links.

BMC 110 is coupled to retimer 105 via a sideband channel 115. The sideband channel carries data about the state of a link that is gathered by retimer 105, referred to hereafter as telemetry. The sideband channel is an I²C channel in the embodiments shown and discussed below, but this is not limiting on the scope as another type of channel can be used instead. For example system management bus, universal asynchronous receiver/transmitter (UART), serial peripheral interface (SPI) or other channels may be used as well.

Retimer 105 is configured to retime one or more data lanes that each carry data. To this end, retimer 105 includes a number of physical-layer circuits (PHYs) configured to enable transmission and reception of data. Each PHY is associated with one data lane that transports data (hereafter ‘lane’) simultaneously in an outbound direction and an inbound direction. Lanes can be grouped together into a link that comprises two or more lanes and a corresponding number of PHYs. Eight PHYs are shown in FIG. 1 but this is not limiting as any number of PHYs (and hence lanes) can be present. Typically the number of PHYs is a power of two, e.g. 2, 4, 8, 16, 32 etc., but this is not limiting as other numbers of PHYs can be present instead. The maximum number of lanes supported is one half of the number of PHYs, since each lane requires two PHYs, and hence FIG. 1 supports a maximum of 4 lanes. This is also not limiting as other numbers of lanes can instead be supported.

Retimer 105 is configured to obtain telemetry information relating to at least one of the one or more data lanes using a telemetry gathering circuit. The telemetry gathering circuit may take various forms as described below, including but not limited to: a logical analyzer, temperature sensor, and various other circuits. Furthermore, the telemetry gathering circuit may be configurable to perform modifications of C-SKPs to exchange telemetry information, as described below. Such a portion of the telemetry gathering circuit may reside in between the PCS encoder/decoder circuitry, adjacent to the elastic buffer. The telemetry gathering circuit may be configured to snoop C-SKPs received via the upstream port for telemetry request commands, and may responsively gather the desired telemetry data and overwrite portions of the C-SKPs received via the downstream port to convey the telemetry data back to the root complex. In some embodiments, the C-SKPs are overwritten prior to being written to the elastic buffer, upon being read from the elastic buffer, or within the elastic buffer itself. In at least one embodiment, the telemetry gathering circuit may maintain or otherwise obtain a write pointer to locations within the elastic buffer containing the C-SKPs. Telemetry refers to information about the state of a link that retimer 105 is part of, e.g. a PCIe link. Telemetry is classified in two categories in this disclosure. The first category is physical-level telemetry. This relates to parameters and properties of a link itself and lanes within the link, e.g. a PCIe link and the lanes constituting the link. In the case of retimer 105, physical-level telemetry can be collected by one or more of the PHYs shown in FIG. 1.

The physical-level telemetry can include any one of more of: a lane identifier of the respective lane, a lane speed of the respective lane, an upstream uptime of the link, a downstream uptime of the link, an upstream configuration of the link, a downstream configuration of the link, a firmware unique identifier (UID) of the retimer, a number of correctible errors of the respective lane, a number of retransmits of the respective lane, a vertical eye metric of the respective lane, a horizontal eye metric of the respective lane, a drift in error rate of the respective lane, and a bathtub floor bit error rate of the respective lane. This list is not exhaustive.

A second category of telemetry in this disclosure is logical-level telemetry. The logical-level telemetry is associated with at least one of the one or more data lanes and is collected by a logical-level telemetry gathering circuit configured to collect the logical-level telemetry.

Logical-level telemetry refers to logical states that a lane or link may be in such as the L0 or L1 states defined by the PCIe specification. Such states can be stored by a state machine referred to herein as a ‘retimer training and status state machine’ (RTSSM). Logical-level telemetry can be collected by a logical-level telemetry gathering circuit. An example of a logical-level telemetry gathering circuit is a logic analyzer 120, but this is not limiting as any component capable of performing this function can be used instead. In the case of a PCIe link and retimer 105 being a PCIe retimer, the logic analyzer can be configured to monitor PCIe data link health on the PCIe retimer 105.

Link health can include monitoring link parameters that are indicative of good functioning of the link, e.g. an error rate of one or more lanes of the link. Corrective action can be taken based on the link health. For example, if a particular lane is consistently giving a higher error rate than other lanes of a link, this lane could be labelled as error-prone and not used where possible. Repair and replacement of components in a data center can be scheduled based at least in part on link health measurements.

In some embodiments retimer 105 is configured to collect just physical-level telemetry and in order embodiments retimer 105 is configured to collect both physical-level telemetry and logical-level telemetry. Embodiments in which just logical-level telemetry is collected are also contemplated.

Retimer 105 is configured to transmit the telemetry to BMC 110 via the sideband channel. The sideband channel can be an I²C channel, for example.

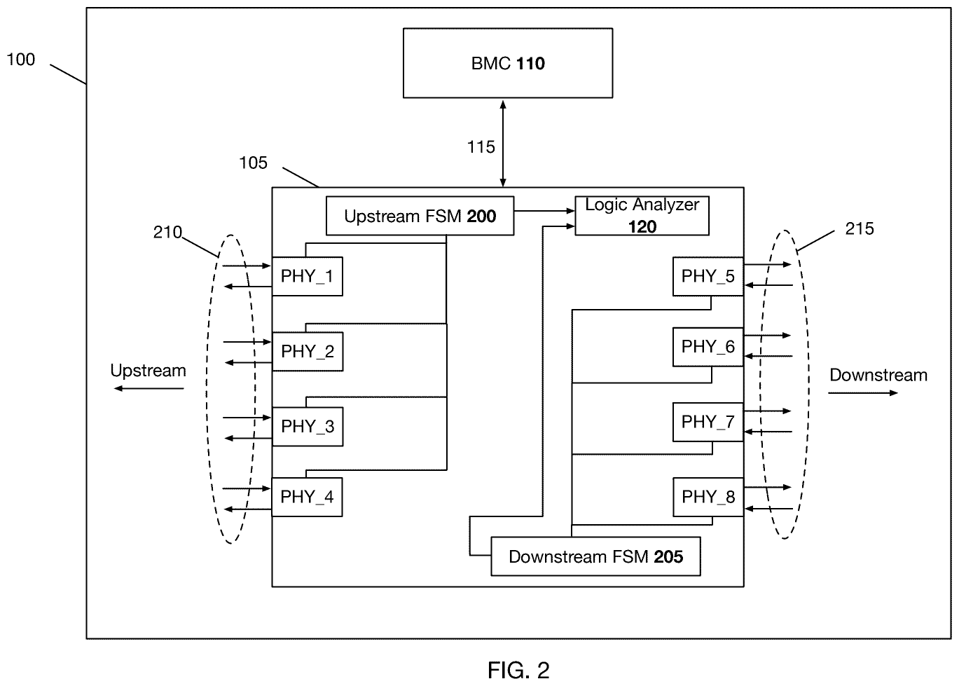

FIG. 2 shows the retimer 105 of FIG. 1 with certain elements shown in more detail. Specifically, a retimer circuit die is shown having upstream 210 and downstream 215 pseudo ports (PPs). As shown, the PHYs in the upstream PP 210 are controlled via an upstream finite state machine (FSM) 200 while the PHYs in the downstream PP 215 are controlled via a downstream FSM 205. While these are shown as separate components in FIG. 2, a single FSM can alternatively store both the upstream and downstream states. The upstream FSM 200 stores a state of a link in the upstream direction and the downstream FSM 205 stores the state of the link in the downstream direction. In the case of a PCIe link, the state can be any of the possible link states defined in the PCIe protocol, e.g., ‘L0’, ‘L1’, etc. These FSMs are interchangeably referred to herein as ‘retimer training and status state machines’ (RTSSMs).

If present, the logical-level telemetry gathering circuit (e.g., logic analyzer 120) can be configured to: read the upstream pseudoport state from the upstream state machine, read the downstream pseudoport state from the downstream state machine and include the upstream pseudoport state and the downstream pseudoport state in logical-level telemetry that is transmitted to the BMC 110. The logical-level telemetry gathering circuit can also be configured to read data from one or more lanes of a multi-lane link that retimer 105 is retiming.

This combination of logical-level telemetry with data can be used to support diagnostic activities.

In the embodiment of FIG. 2 upstream has been selected as the direction to the left and downstream to the right, without implying any limitation. Upstream refers to the direction in which a host, root complex or other such controlling entity is located. Conversely, downstream refers to the direction in which an endpoint, switch or other such controlled entity is located.

In FIG. 2 the link depicted is a ×4 link that involves 4 lanes. Each lane is associated with two PHYs, one in the upstream direction and one in the downstream direction. In FIG. 2, for simplicity PHYs opposite one another in the figure are part of the same lane—i.e., PHY_1 and PHY_5 form a lane, PHY_2 and PHY_6 form another lane, and so on. None of this implies any limitation as any number of lanes can alternatively be present, e.g., a ×2, ×8, ×16, ×32 lane link and so on. It is also not required that physically opposing PHYs form a lane, as instead PHYs that are not physically opposite one another can form a lane.

As noted above, lanes can be grouped into a link. In FIG. 2 a single ×4 link is shown, comprising four lanes each comprising two of the eight PHYs shown. This is not limiting as eight PHYs can support other combinations such as: two ×2 links, one ×2 link and two ×1 links. More PHYs can be provided to increase the maximum link size, e.g., ×8, ×16, ×32 links.

The link has two pseudoports (PPs): upstream-facing PP 210 and downstream-facing PP 215. Each PP is formed of the collection of PHYs that are associated with the link in the relevant direction. Upstream-facing PP 210 is thus formed of the collection of PHYs PHY_1, PHY_2, PHY_3 and PHY_4, and downstream-facing PP is formed of the collection of PHYs PHY_5, PHY_6, PHY_7 and PHY_8. All PHYs that are part of a given PP share a link state because they act in concert in the same link. In the following description, the “upstream-facing PP” and “downstream-facing PP” may be referred to as “upstream PP” and “downstream PP”, respectively. The link state at upstream PP 210 is related to the link state at downstream PP 215, but they are not always identical. Thus, upstream PP 210 and downstream PP 215 can have the same state at a given time, or a different state. Changes in the state of one PP can cause a change in the state of the other PP.

Upstream FSM 200 stores the current state of the upstream PP 210, e.g., the link parameters negotiated when the link was established and trained. In order to do this upstream FSM 200 receives state-related information from all of the PHYs that are part of upstream PP 210. Similarly, downstream FSM 205 stores the current state of the downstream PP 215. In order to do this downstream FSM 205 receives state-related information from all of the PHYS that are part of downstream PP 215. State-related information can include, for example, an indication that a PHY has detected electrical idle symbols or training symbols, or that the PHY is currently transmitting and/or receiving data. These examples are not limiting as any condition of a PHY can be included in the state-related information.

The state of upstream FSM 200 and/or the state of downstream FSM 205 can be captured and stored by logic analyzer 120. Logic analyzer 120 can be configured to capture states of upstream FSM 200 and/or downstream FSM 205 over time, e.g., to trigger each time a state of one of these entities changes and to capture this information. This can be useful information when debugging as it shows how and when the state of a link changed. The logic analyzer 120 can be triggered by a state change to start capturing data, or it can continuously capture data by continually overwriting the content of its buffer and then be triggered by a state change or other event to store the current content of the buffer. In this way triggering ‘after the event’ is possible. It is also possible to continue capturing data for some preset time after a trigger is detected, so that the analyzer output provides data captured preceding the trigger and also following the trigger.

Thus far the description has focussed on retimers having just a single die. Multi-die retimer embodiments are also contemplated, e.g., two dies or four dies.

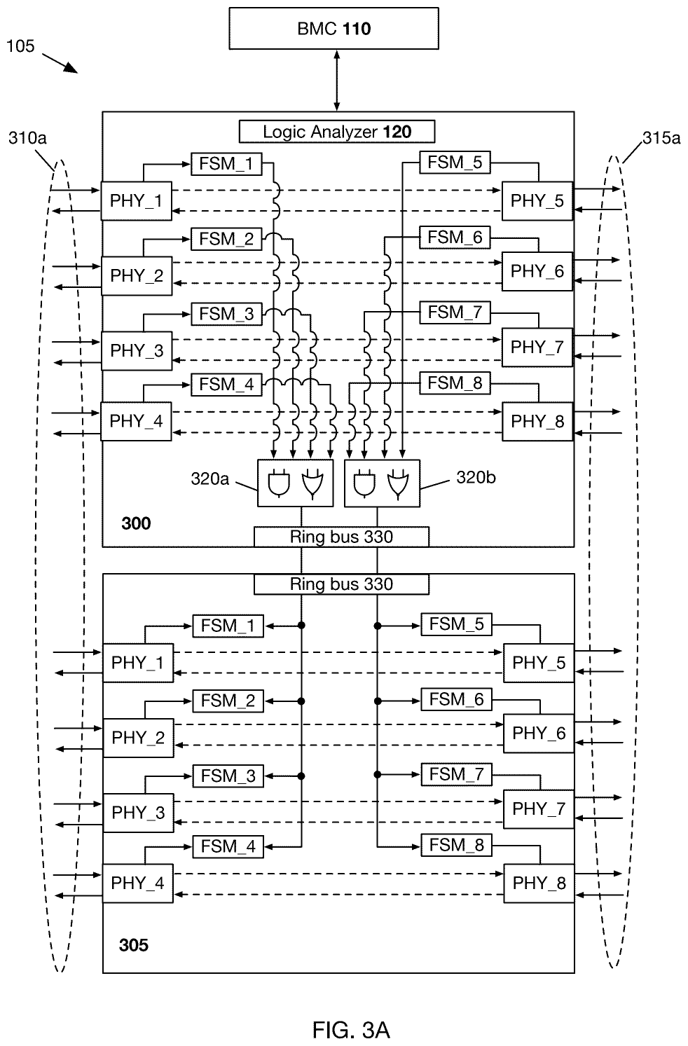

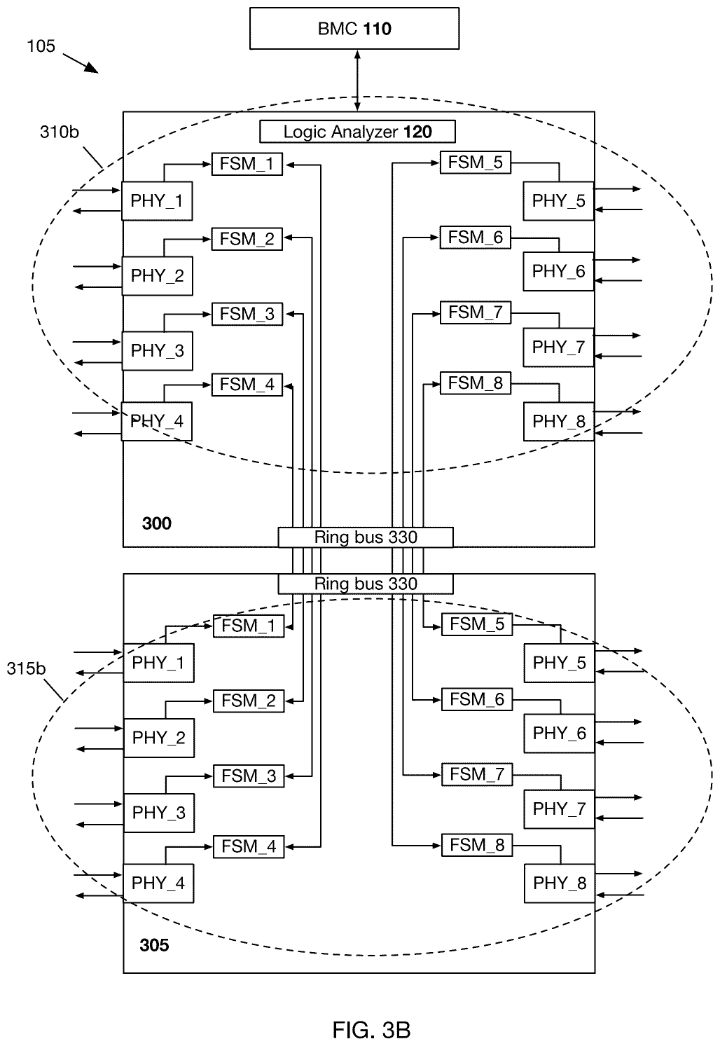

FIG. 3A shows a two-die retimer according to an embodiment. In addition to the components described above, the two-die retimer includes a second die 305 comprising: a second plurality of PHY circuits configured to participate in the multi-lane link, each of the second plurality of PHY circuits corresponding to a respective lane of the multi-lane link and being part of either the upstream pseudoport 310a of the link or the downstream pseudoport 310b of the link; a second upstream state machine configured to store the upstream pseudoport state of the upstream pseudoport; and a second downstream state machine configured to store the downstream pseudoport state of the downstream pseudoport.

In some embodiments the second die further comprises a second logical-level telemetry gathering circuit configured to: read the upstream pseudoport state from the second upstream state machine, read the downstream pseudoport state from the second downstream state machine and include the upstream pseudoport state and the downstream pseudoport state in the logical-level telemetry.

Each upstream state machine can comprise a plurality of upstream state machines each associated with a respective one of the plurality of upstream PHY circuits. Similarly, each downstream state machine can comprise a plurality of downstream state machines each associated with a respective one of the plurality of downstream PHY circuits. The state machines can be RTSSMs as discussed herein. Such embodiments with a plurality of state machines can be referred to as having a distributed or decentralized state machine.

A multi-die retimer such as that shown in FIG. 3A can include a single CPU on a leader die. Alternatively, CPUs may be physically present on all dies but only the CPU on the leader die is active. Dies with no CPU/an inactive CPU are termed follower dies. The CPU on the leader die can be configured to coordinate collecting of telemetry of all dies that participate in a given link. Telemetry can be sent between tiles using a tile-to-tile (T2T) bus, e.g. a T2T SPI bus.

A decentralized RTSSM is shown in FIG. 3A in which each PHY on each die 300, 305 has a corresponding RTSSM (‘FSM’in FIG. 3A). In order to support the multi-die architecture, each PHY has an associated RTSSM so that there is the same number of RTSSMs as PHYs. This distributed RTSSM can offer more flexibility in terms of link configuration than the embodiment shown in FIG. 2 as it allows any collection of PHYs to form a link. This enables the retimer circuitry to be distributed over multiple dies, with synchronisation of RTSSM states between the dies being enabled as discussed below.

Lanes in FIG. 3A are formed of physically opposite PHYs, i.e., an upstream PHY and a corresponding downstream PHY, and data traffic flows between PHYs in the same lane in the horizontal direction as shown by dashed arrows in FIG. 3A.

Also as shown in FIG. 3A, the retimer circuit die includes respective RTSSMs configured to manage each PHY on the retimer. In such an embodiment, the RTSSMs managing the PHYs of a given pseudo-port (PP) type are configured to exchange intra-PP state information, while the RTSSMs of two PHYs that make up a lane are each configured to exchange inter-PP state information. Such a retimer circuit die offers highly flexible lane routing capabilities over a retimer including a single FSM to manage the link, however such a constraint should not be considered limiting.

An example of this additional flexibility is shown in FIG. 3A in which the decentralised RTSSM configuration discussed above is deployed. In this case retimer 105 is formed by a multi-chip module (MCM) that comprises first and second retimer circuit dies 300, 305. In this case a ×8 link is shown, with 4 lanes on first retimer circuit die 300 and 4 lanes on second retimer circuit die 305. Upstream PP 310a now spans both circuit dies, as does downstream PP 315a. Other link configurations are possible: two ×4 links, four ×2 links, one ×4 and two ×2 links, and eight ×1 links. For any given link having N lanes, 2*N RTSSMs are active.

Generally, a decentralised RTSSM comprises a plurality of upstream state machines each associated with a respective one of the plurality of PHY circuits and the downstream state machine comprises a plurality of downstream state machines each associated with a respective one of the plurality of PHY circuits. In the case of a MCM like that shown in FIG. 3A, each circuit die has its own decentralised RTSSM, shown in FIG. 3A as a second plurality of upstream state machines on circuit die 305 each associated with a respective one of the plurality of PHY circuits on circuit die 305 a second plurality of downstream state machines on circuit die 305 each associated with a respective one of the plurality of PHY circuits on circuit die 305.

In cases where a link spans multiple circuit dies, as in the case illustrated, it is necessary to synchronize all RTSSMs participating in the link by exchanging inter-pseudo-port (inter-PP) RTSSM status information between the two RTSSMs participating in the same lane but of opposite pseudo-port type (also referred to herein as horizontal synchronization) using a horizontal synchronization channel. Furthermore, intra-pseudo-port (intra-PP) RTSSM status information is exchanged between RTSSMs of the same pseudo-port type (also referred to herein as vertical synchronization) using a vertical synchronization channel.

In the embodiment shown in FIG. 3A, exchange of the inter-PP RTSSM status information is possible via direct connection between PHYs of the same lane but of opposing PP type because these PHYs are located on the same die. However, exchange of intra-PP RTSSM status is more complex because some of the PHYs of a given PP type are located on a different die to others of the PHYs of that PP type. More information about the exchange of intra-PP RTSSM status is provided below.

Inter-PP RTSSM status information may be exchanged e.g., in a receiver detection process. For example, when a root complex initiates receiver detection, the root complex interacts with upstream RTSSMs. The endpoint is connected to the downstream RTSSMs. Each downstream RTSSM is notified, via the respective horizontal sync bus (not shown), to initiate receiver (i.e., endpoint) detection. When the downstream RTSSMs detect the endpoint, they may signal back to the upstream RTSSMs via the horizontal sync bus that the endpoint has been detected and the next processes in the link training may begin.

In addition to horizontal synchronization, as noted above RTSSMs of the same pseudo-port type exchange intra-pseudo-port (intra-PP) RTSSM status information for notifying other RTSSMs of the same pseudo-port participating in the link about current state machine status that may be useful for synchronously progressing all of the RTSSMs of the same pseudo-port between states. Intra-PP RTSSM status information may include AND conditions, e.g., the RTSSMs of a pseudo-port type progress to a new state if a condition is found in every lane, and OR conditions, e.g., the RTSSMs progress to a new state if the condition is found in any lane.

In order to enable this, combinatorial logic 320a, 320b is located on each of the circuit dies, each instance of the combinatorial logic being configured to aggregate a condition of each of the plurality of PHY circuits of a given PP type on the respective circuit die to produce an aggregated condition. The condition of a PHY can be obtained from the RTSSM corresponding to the PHY. The condition of a PHY can be any parameter or property of the PHY, e.g., the PHY is transmitting electrical idle symbols, or the PHY is transmitting data, or the PHY has detected a training ordered set, or the PHY has encountered an error condition, etc.

There may be one block of combinatorial logic for each PP type on each circuit die. Thus, in the case of FIG. 3A, there are four blocks of combinatorial logic in total-one for upstream PP 310a on circuit die 300, one for downstream PP 315a on circuit die 300, one for upstream PP 310a on circuit die 305, and one for downstream PP 315a on circuit die 305. In FIG. 3A only the blocks of combinatorial logic on circuit die 300 are shown, for reasons of clarity of illustration. Two additional combinatorial logic blocks (not shown) are also present on circuit die 305 and operate to gather a condition of each PHY of each PP type on circuit die 305 and transport the resulting signal to the RTSSMs associated with the same PP type on circuit die 300. The combinatorial logic blocks may be configurable to receive the AND and OR conditions for only the lanes participating in the link. In some embodiments, additional combinatorial logic blocks with selectable inputs may be included to support multiple PCIe links operating in parallel across the MCM.

Each block of combinatorial logic 320a, 320b can comprise AND gate(s) and OR gate(s). Each gate has one input for each PHY of a given PP type on the circuit die that the combinatorial logic is located on. In the embodiment of FIG. 3A, as there are four PHYs of a given PP type on each die, each block of combinatorial logic can comprise an AND gate with four enabled inputs and an OR gate with four enabled inputs. Each gate may further include 4 disabled or otherwise unused inputs for the other four PHY circuits on the circuit die 300. These numbers are not limiting as in the case of more or fewer PHYs, the number of inputs to each of the AND and OR gates can be adjusted accordingly.

Thus, each block of combinatorial logic receives state information from all of the RTSSMs associated with a given PP type on one die and transmits the resulting output to each RTSSM on the other die. The output of the combinatorial logic is referred to herein as an aggregated condition. Each RTSSM on the other die stores the aggregated condition as part of the upstream PP state or downstream PP state, depending on whether the RTSSM is associated with a PHY that is part of the upstream PP or the downstream PP. In the case of each block of combinatorial logic comprising an AND gate and an OR gate, an aggregated AND condition and an aggregated OR condition is transmitted to each RTSSM on the other die.

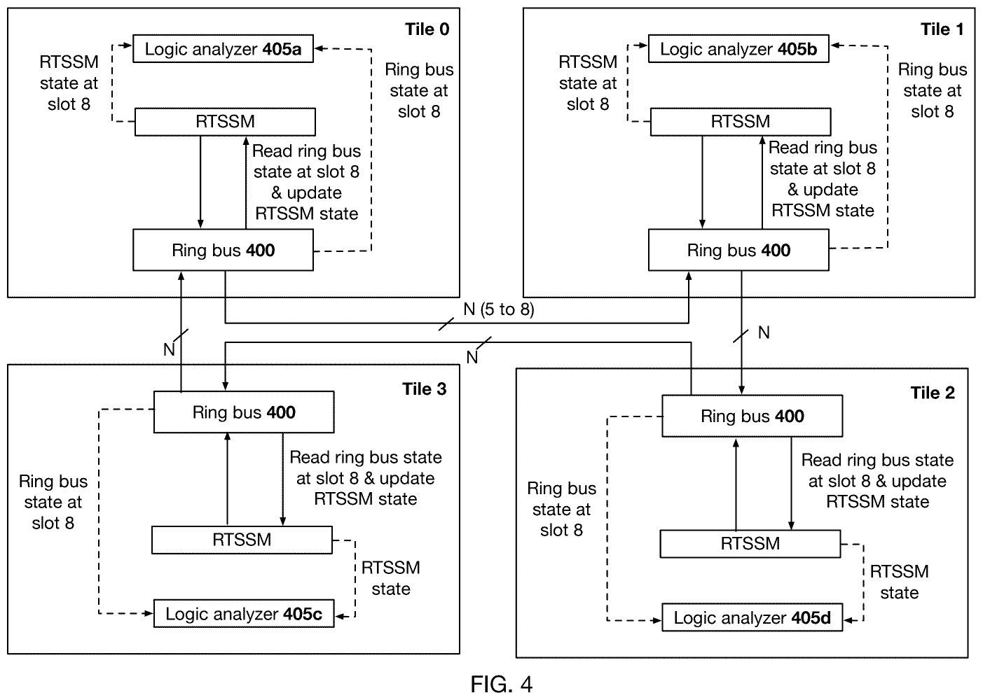

Communication between die 300 and die 305 can be enabled by a die-to-die (D2D) interface. The D2D interface can be a multi-wire D2D interface, referred to herein as a ring bus 330 (see also FIG. 4).

FIG. 3B shows an alternative ×8 lane configuration involving two dies 300, 305. In this embodiment the upstream PP 310b involves all PHYs on die 300 and the downstream PP 315b involves all PHYs on die 305. Data traffic is not shown in FIG. 3B in the interests of clarity, and instead the following table is used to describe a possible link configuration.

| Lane number | Upstream PHY (die 300) | Downstream PHY (die 305) |
|---|---|---|
| Lane_0 | PHY 4 | PHY 1 |
| Lane_1 | PHY 3 | PHY 2 |
| Lane_2 | PHY 2 | PHY 3 |
| Lane_3 | PHY 1 | PHY 4 |
| Lane_4 | PHY 8 | PHY 5 |
| Lane_5 | PHY 7 | PHY 6 |
| Lane_6 | PHY 6 | PHY 7 |
| Lane_7 | PHY 5 | PHY 8 |

This link configuration is not limiting as other couplings between PHYs are possible.

PP status information exchange in FIG. 3B is opposite to that of FIG. 3A. Exchange of intra-PP RTSSM status information is possible via direct connection between PHYs of the same PP type because these PHYs are located on the same die. However, exchange of inter-PP RTSSM status is more complex because a PHY at one end of a lane is located on a different die to the corresponding PHY at the other end of the lane.

In this configuration the intra-PP information generated by the combinatorial logic is not sent via the ring bus 330 because all RTSSMs associated with PPs of the same type are located on a single die and can therefore exchange the aggregated AND and OR conditions for the PP directly. Instead, in this case the ring bus is used to transport lane condition information from a PHY on one tile to the corresponding PHY that is part of the same lane on the other tile. This transport of information is shown via the solid lines passing through ring bus 330 in FIG. 3B.

The multi-tile techniques discussed above can be extended to arrangements with more than two dies. FIG. 4 is a block diagram of a multi-chip module (MCM) including a plurality of retimer circuit dies, in this case four circuit dies. Each circuit die includes RTSSMs for each PHY as described above, although just one RTSSM in shown in FIG. 4 in the interests of clarity.

As shown, the MCM includes a ring bus 400 interconnecting the circuit dies to exchange RTSSM status information. Ring bus 400 can be used in the embodiment of FIG. 3A or FIG. 3B. The ring bus may be configured to exchange intra-PP status information if PHYs of the same pseudo-port type are distributed across multiple circuit dies. In such a configuration, the RTSSMs of the two PHYs making up each lane are located on the same circuit die and the inter-PP status information may be exchanged directly using an on-die channel. Detail on RTSSM synchronization across multiple tiles can be found in [Koch].

Ring bus 400 is a slot-based bus. In this instance there are 9 time slots each corresponding to a respective clock cycle of a reference clock, e.g. a 100 MHz reference clock that is accessible to all four dies. In some embodiments, the ring bus is a 9-wire bus, having one wire dedicated for conveying a synchronization bit, and each of the remaining eight wires carrying horizontal or vertical synchronization information.

In a configuration like that shown in FIG. 3A that makes use of combinatorial logic, each wire carries a signal corresponding to an output of a respective block of combinatorial logic, e.g., either an AND condition or an OR condition. As there are two blocks of combinatorial logic per die (one for the upstream PP and one for the downstream PP), each with two outputs (AND and OR), and four dies, this totals 2×2×4=16 aggregated outputs across the entire retimer.

In a configuration like that shown in FIG. 3B that does not convey the outputs of the combinatorial logic across the ring bus, the ring bus may be used to convey inter-PP information for each lane. In some embodiments, the inter-PP information for each lane includes up to (but not limited to) 8 bits, and the inter-PP information for each lane may be sent via the ring bus using the e.g., 8 time slots.

None of the specific numbers discussed above are limiting as it will be appreciated that they are all dependent on the number of PHYs per circuit die and number of circuit dies in total. Embodiments with a ring bus with a different number of wires and time slots corresponding to different numbers of PHYs and/or circuit dies are thus contemplated.

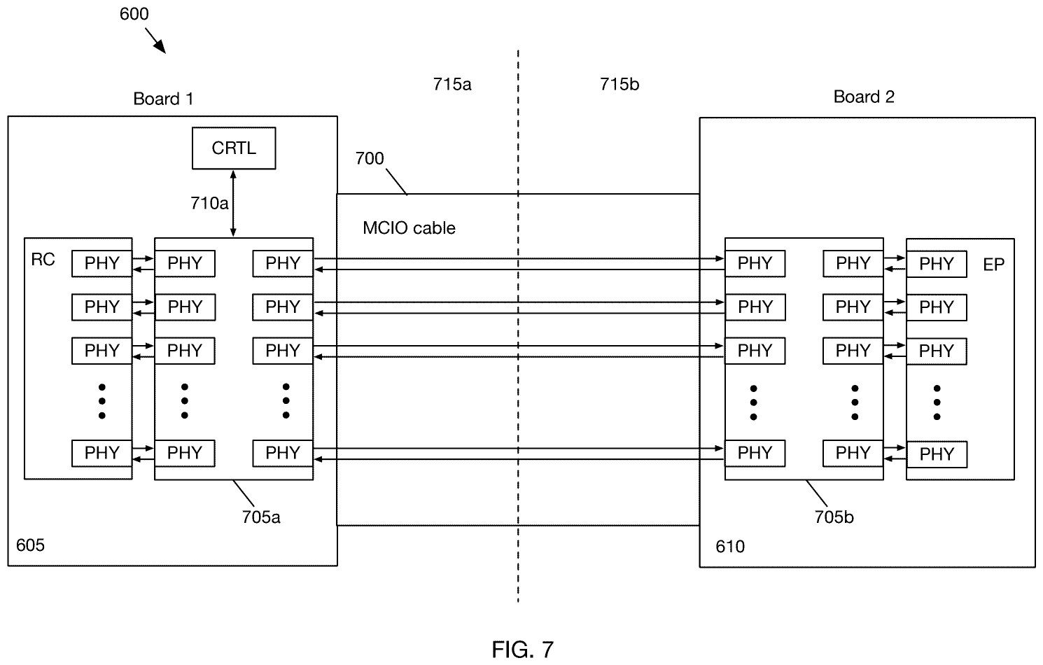

Irrespective of the signal type that the ring bus carries, the operation is as follows. Each ring bus has a ring counter that runs in a loop from 0 to 8. The ring counter is advanced according to a reference clock, i.e., the ring counter advances by a count of 1 unit each cycle of the reference clock. In one embodiment, ring bus 400 includes 5 wires and 9 time slots to cycle the aggregated state information for each tile to every other tile. In slot 0, each tile puts their own AND and OR conditions for the upstream and downstream PPs onto the ring bus 400. In slot 1, each tile stores the AND and OR conditions of the immediate predecessor tile. In slot 2, each tile puts the AND and OR conditions of the immediate predecessor on the ring bus to the next tile. In slot 3, each tile stores the AND and OR conditions of the two-prior tile. In slot 4, each tile puts the AND and OR conditions of the two-prior tile on the ring bus 400. In slot 7, all tiles have received all conditions from every other tile, and the RTSSMs may change state. Slot 8 may correspond to a synchronization time slot in which a sync bit is propagated around to synchronize the slot counters in each tile. The number of wires and/or time slots in this example should not be considered limiting. More details on the synchronization process carried out to ensure that each ring counter on each circuit die is aligned may be found in [Koch], see in particular the sections headed ‘RTSSM Synchronization’ and ‘Multi-Tile RTSSM Synchronization’ (paragraphs to [0088], FIGS. 7-15).

As shown in FIG. 4, the logic analyzer 405a, 405b, 405c, 405d on each circuit die is configurable to read RTSSM status information. As the ring bus has been used to exchange RTSSM status information between circuit dies, upon a complete ring cycle the logic analyzer on any given circuit die has access to RTSSM state information (e.g., AND/OR conditions) of every circuit die.

In some embodiments, one of the circuit dies is designated as a “leader”. The leader circuit die may be instructed, via e.g., an SMBus connection, to report RTSSM state information. The logic analyzer of the leader circuit die may log the AND/OR conditions received from each circuit die during the RTSSM synchronization process. In some embodiments, the AND/OR conditions may offer insight as to which circuit die contains the RTSSM that e.g., experienced an interruption, and may thus be useful diagnostic information. Once the problematic circuit die is identified, the logic analyzer on the problematic circuit die may be configured to output more specific state information from RTSSMs on the circuit die to diagnose what led to the problem on the lane of the link.

This can occur in a multi-pass process. In the first pass, aggregated conditions (AND/OR conditions) can be gathered by the logic analyzers and analyzed, e.g. by a retimer CPU. This enables a specific PP on a particular circuit die to be identified where an issue is present. The logic analyzer on the specific circuit die can then be instructed to gather more data relating to the PHYs that are part of this PP. On this second more detailed pass, the logic analyzer can instead collect PHY_specific information, e.g. a state of each RTSSM associated with the PHYs that form the PP having the issue. This more specific information can then be analyzed, e.g. by a retimer CPU, to identify one or more specific PHYs that are causing the issue. This can assist a diagnostic process because it is possible to identify a specific lane and specific PHYs that are contributing to an issue.

As shown in FIG. 4, each circuit die includes a respective logical-level telemetry gathering circuit that in this embodiment takes the form of logic analyzers 405a, 405b, 405c and 405d. This is not limiting as in an alternative embodiment only some of the circuit dies include a logical-level telemetry gathering circuit, e.g., only the leader circuit die. Additionally, the logical-level telemetry gathering circuit(s) can be an alternative to a logic analyzer that is capable of performing the functions described herein.

Each logic analyzer 405a-405d is communicatively coupled to a respective RTSSM located on the same circuit die as the logic analyzer. This allows each logic analyzer to capture the state of the RTSSM. Each logic analyzer can be configured to trigger on a certain condition, e.g., a change of state of the RTSSM to which it is communicatively coupled. This allows a history of states of an RTSSM to be captured and stored by the respective logic analyzer, with the number of historical states being governed by the depth of the buffer in which the logic analyzer stores the RTSSM states. Having a history of RTSSM states can be useful when troubleshooting a problem. In the case where the RTSSM is a decentralized RTSSM, the logic analyzer can capture the AND/OR conditions received from each circuit die during the RTSSM synchronization process as discussed above.

Additional parameters that may be collected by each retimer and conveyed to a management entity such as a BMC, or relayed to a peer retimer entity for further reporting to a management entity, include, as examples:

| Parameter | Data Type |
|---|---|
| Device UID | String |
| unique port ID | |
| Upstream Link config (Lanes, speed) | Integer, Integer |
| Root complexes may have a NA entry | |
| Downstream Link config (Lanes, speed) | Integer, Integer |
| End points may have a NA entry | |
| Upstream Link uptime | Time |
| Time since last status change - if applicable | |
| Downstream Link uptime | Time |
| Time since last status change - if applicable | |
| Firmware UID | String |
| Retimer Unique ID (stored in firmware) | |
| Per Lane: | |
| Number of correctible errors | Integer |
| Leaky bucket implementation. Time constants are | |
| configurable | |
| Number of retransmits | Integer |
| Leaky bucket implementation | |
| Vertical eye metric | Integer |
| Proxy for link insertion loss (may be PHY dependent) | |
| Horizontal eye metric | Integer |
| Proxy for link jitter (may be PHY dependent) | |
| Drift in error rate | Integer |
| Derivative of leaky error rate, indicator of change in | |
| link health | |
| Bathtub floor BER | Integer |
| Estimated | |
| RTSSM state | String |
| Current / historical state of the RTSSM | |

This list is not exhaustive or limiting as alternative parameters to those shown above can be additionally or alternatively collected by the retimer. Some of these parameters are physical-level parameters that are measured/determined by a PHY and can thus be retrieved from each PHY of the retimer, e.g. eye metrics and bathtub floor bit error rate (BER). Others of these parameters, like RTSSM state, are logic-level parameters that can be captured by a logical-level telemetry gathering circuit. Yet others of these parameters are retimer configuration parameters, e.g., firmware UID, that can be retrieved via retimer core logic such as a CPU of the retimer.

Other parameters that are contemplated include: temperature, e.g. a temperature of the retimer as measured by a temperature sensor, or a temperature of another component such as an endpoint, root complex, etc., as measured by a temperature sensor, error flags and/or error counters.

An error flag can indicate a specific error condition as one error flag can be defined for each error condition. A look up table or other such repository of error flags and their corresponding conditions can be maintained by the retimer and also by other entities like BMC 110 such that it is possible for the other entities to interpret a retimer error upon receipt of the corresponding error flag as can be sent over an in-band or sideband channel. This allows a BMC to understand the status of a given retimer at any given time by inspecting the current list of errors. An error count indicates the number of times a particular error has occurred over a certain time period.

Retimers with telemetry-gathering circuits as discussed above have utility in various real-world deployment environments. One such environment a data center and the following discussion focusses on gathering telemetry using a retimer according to any of the embodiments of this application in this environment. This environment is however not limiting, as retimers described herein can be used in any environment in which telemetry reporting is desired.

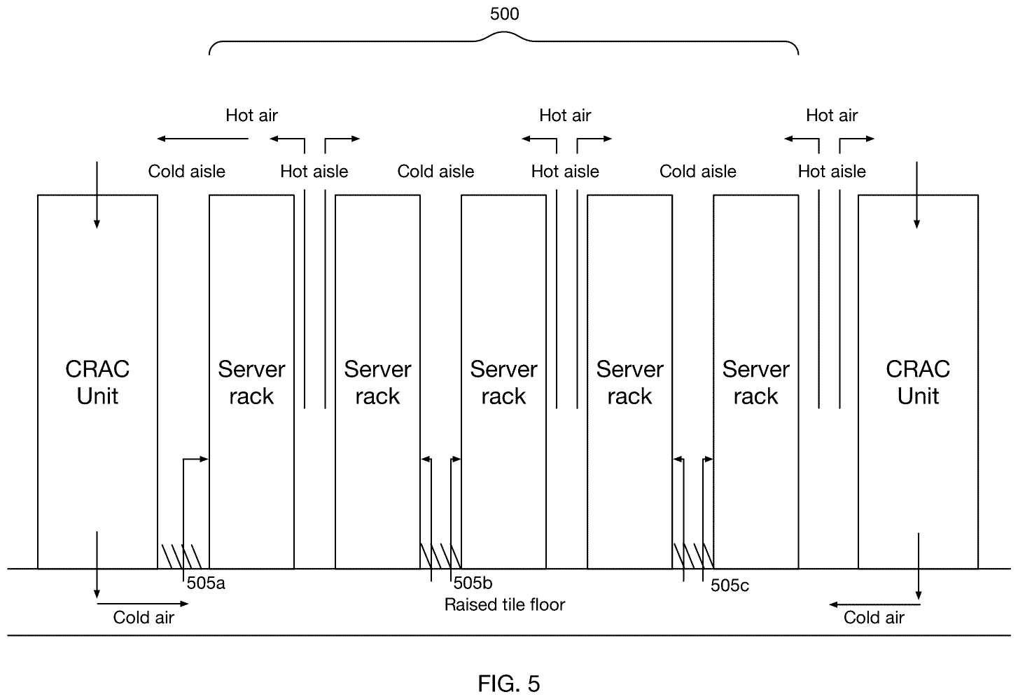

FIG. 5 illustrates a data center environment at a high level, to provide context for the following discussion. The data center includes a group of server racks 500 that each houses a plurality of servers, e.g. mounted in one or more chassis within the respective server rack. Many groups of server racks like group 500 can be present in total within a single room or set of interconnected rooms that collectively comprise the facility in which the data center is housed.

As there are a large number of server components in simultaneous operation, a significant amount of heat can be generated within the room in which the server racks 500 are located. For this reason a pair of Computer Room Air Conditioning (CRAC) units are located at either end of the group of server racks 500. Each CRAC is configured to take in hot air from the surroundings of the server racks 500, cool the air and expel cold air. In the configuration shown the room housing server racks 500 has a raised tile floor that enables air to flow beneath the room housing the server racks 500. Each CRAC is configured to expel cold air into the void provided by the raised tile floor. Vents 505a-505c are provided in the upper part of the floor to enable the cold air to pass from the void within the floor to the room housing the server racks 500.

As shown, the server racks are arranged in parallel to one another to create a series of aisles between adjacent server racks. Vents 505a-505c are placed such that every other aisle is cooled as one moves perpendicular to the aisle direction (i.e., from one rack to the next). These cooled aisles are referred to as ‘cold aisles’. Cooling one side of each server rack in this manner tends to cause hot air to flow out along the opposite side of each server rack, creating a series of alternating cold aisles and hot aisles. This promotes air flow throughout the room housing server racks 500 as shown in FIG. 5, ensuring that all servers remain cool enough to operate effectively at all times. This air conditioning arrangement is purely exemplary and can be varied in many ways whilst still providing effective cooling of the server racks 500.

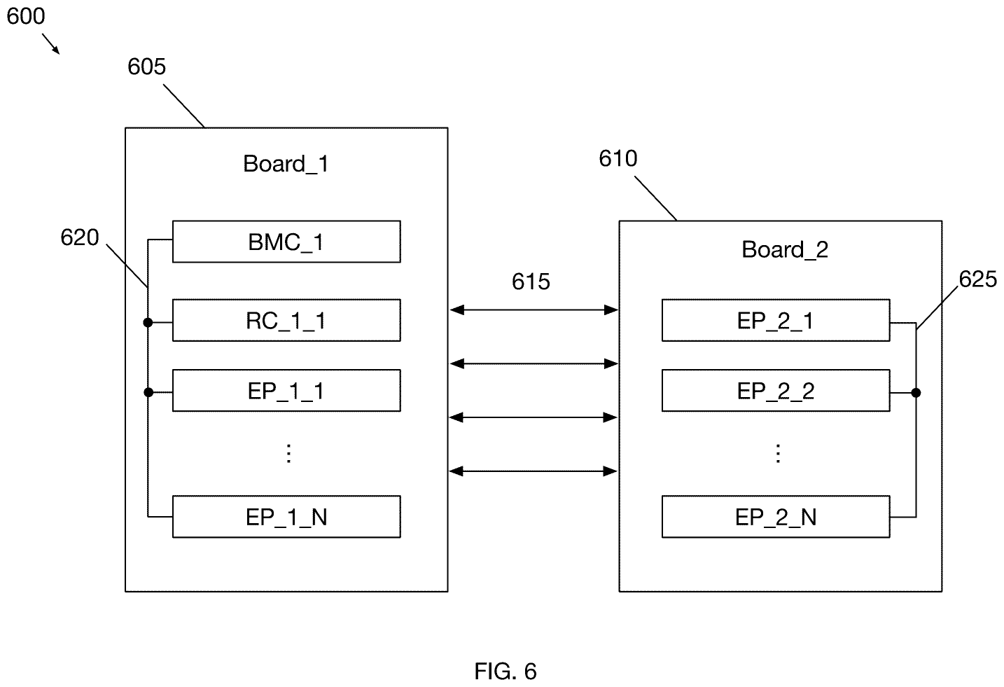

A consequence of the aisle-based physical layout required to enable sufficient cooling is that cabling is required to enable communication between servers in different racks. FIG. 6 is a block diagram of a server rack 600 comprising a first board 605 and a second board 610 interconnected via cables 615. Board 605 may be e.g., a server. As shown, board 605 includes a board management controller (BMC), a root complex (RC) as well as a plurality of endpoint devices (‘EP’). Board 610 includes a plurality of endpoint devices accessible by the root complex on board 605 via the cables 615.

The first board 605 and second 610 are communicatively coupled by one or more cables 615. The boards and cables can be of any type known in the art. In some embodiments the cables are active cables containing one or more retimers, as described in detail later in this disclosure.

The first board 605 includes a Board Management Controller, BMC_1, a root complex, and one or more endpoints. In this case N endpoints EP_1_1 to EP_1_N are shown. In general N is a positive integer greater than or equal to 1. BMC_1 is communicatively coupled to each endpoint of the first rack via one or more wires 620, e.g., wires of a system management bus (SMBus). The endpoints can be any type of endpoint, including but not limited to a root complex, a GPU, a switch, a storage device, a network interface card, etc.

The second board 610 one or more endpoints EP_2_1 to EP_2_N. The second board may be e.g., a memory expansion board having memory accessible to the first board 605.

The root complex on the first board 605 can communicate with an endpoint that is part of the second board 610 via the one or more cables 615. A link can be established between the endpoints to facilitate this communication. The link can be a Peripheral Component Interconnect express (PCIe) link, an ethernet link, a USB link, or any other type of protocol.

It will be appreciated that BMC_1 has no direct control connection to the endpoint(s) on the second board 610. This prevents BMC_1 from gathering telemetry relating to the portion of the link that is proximate and/or within the second rack 610.

In some cases, telemetry does not vary with physical position. For example, the number of lanes in a link and the link speed are negotiated when the link is brought up and as such will be the same across the entire length of the link. BMC_1 can thus gather this information from any endpoint within the first board 605 that is participating in the link and does not need to attempt to obtain information from any endpoint in the second board 610.

On the other hand, some telemetry data does vary significantly with physical position. Eye-related parameters such as horizontal eye width and vertical eye height vary according to the location at which they are measured and hence BMC_1 cannot use eye measurements taken e.g., at the end of a cable proximate the first board 605 to infer the state of the eye at the other end of the cable proximate the second board 610. Thus, in general, it is desirable to be able to gather telemetry from a variety of different physical locations over the length of a link to obtain a full picture of the link.

FIG. 7 is a schematic drawing of data center 600 showing certain elements in greater detail. The RC on board 1 is shown coupled to an endpoint EP on board 2 via a single cable 700. This is in the interests of clarity and ease of understanding, as it will be appreciated that this disclosure is not limited to one pair of devices coupled by a single cable. Devices can be coupled by multiple cables and/or multiple devices can be coupled by a single cable.

The RC and EP each include one or more PHYs. In this case four PHYs are shown in each endpoint with a dotted region indicating that additional PHYs can be present. In the case where just only PHYs are present, the link established between the RC and EP can be referred to as a ‘by four’ or ‘×4’ link, as it involves four PHYs. This is not limiting as other link widths can alternatively be used, e.g. ×1, ×2, ×4, ×8, ×16 and ×32 links. The PHYs enable the RC to communicate with the EP(s).

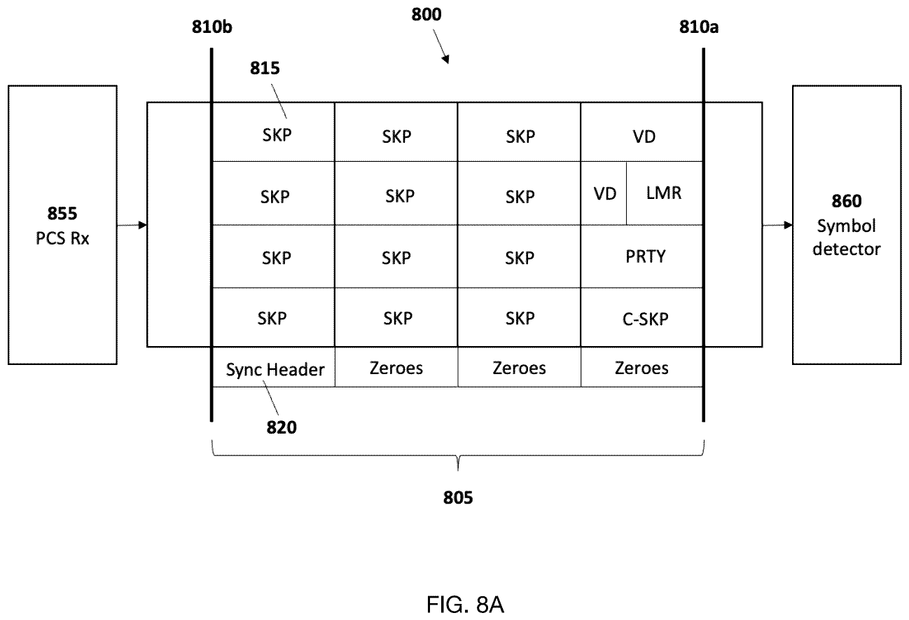

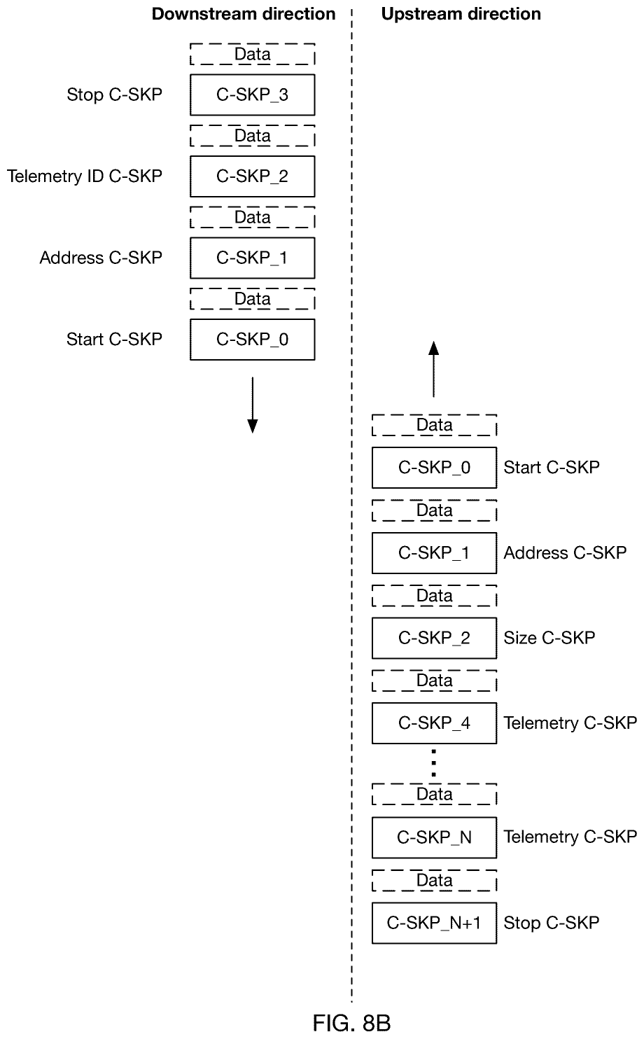

The EP and RC are each coupled to cable 700 via a respective retimer 705a, 705b. Each retimer 705a, 705b is not part of cable 700 in this embodiment-see the embodiment of FIG. 8 for an active cable containing retimers. The retimers can thus be located on the same board as their respective BMCs, or on some other board that is part of the respective rack 605, 610. Each retimer includes its own plurality of PHYs that couple to respective PHYs on RC or EP, to enable communication between these entities. It should be further noted that in some embodiments, only one retimer is utilized, that is only one of retimer 705a or 705b is present. In at least one embodiment where e.g., only retimer 705b is present, the CTRL on board 1 may not have a direct sideband channel to access telemetry information from retimer 705b via cable 700. An embodiment is also contemplated in which only retimer 705a is present, and CTRL may not have a direct sideband connection to retimer 705a, for example if retimer 705a is in a closed-box environment. In such an embodiment, the CTRL may interact with the root complex directly to obtain telemetry data via an in-band channel over the PCIe link between the root complex and retimer 705a.

In FIG. 7 a controller CTRL performs the function of the BMC. The controller CTRL can be a BMC or any other type of controller. Being located in this way means that it is possible for CTRL to communicate with retimer 705a via a sideband connection 710a, e.g., an I²C connection.

In the embodiment of FIG. 7, second board 610 does not have a controller like CTRL. However, this is not limiting as second rack 610 can include a controller like CTRL. If present, the CTRL on second board 610 can communicate with retimer 705b via another sideband connection that is located on second rack 610, e.g., an I²C connection.

Each retimer 705a, 705b can be of the type discussed in any of the preceding embodiments, and may in particular include a logic analyzer or other such circuitry capable of collecting logic-level telemetry.

The link between RC and EP is split conceptually into first 715a and second 715b portions (also referred to herein as sub-links). The first and second sub-links are shown in FIG. 7 by a dashed vertical line, with the left-hand side being the first sub-link 715a and the right-hand side being the second sub-link 715b. From the perspective of CTRL the first sub-link 715a is local because it is possible for the CTRL to obtain telemetry for the first sub-link from retimer 705a. The second sub-link 715b is remote from the perspective of CTRL as is located in a different server rack to the second sub-link 715b. The opposite would be true for a CTRL located on second rack 610, for which the first sub-link 715a is remote and the second sub-link 715b is local.

In practice the divider between the first and second sub-links is not necessarily physically defined, e.g., by a connection point between a board and a cable. The sub-links can be defined in terms of whether a CTRL or other such entity can gain access to accurate and reliable telemetry data for that sub-link without implementing the techniques disclosed herein. As discussed above, this can depend on the type of telemetry data being gathered, e.g., lane speed or link ID can be accurately reported by a PHY at either end of a cable because it does not vary over the entire link, whereas eye measurements vary along the length of the cable and hence an eye measurement carried out by a PHY at one end of the cable can produce different results to an eye measurement carried out by another PHY at the opposite end of the cable.

Cable 700 is a passive cable, meaning that it includes a wire or group of wires for carrying signals and does not include any active electronic components within it. Cable 700 enables data to be transported and can also include one or more sideband pins and corresponding wires that enable sideband information to be transmitted via cable 700. As one example of this, the cable can be a Mini Cool Edge IO (MCIO) cable.

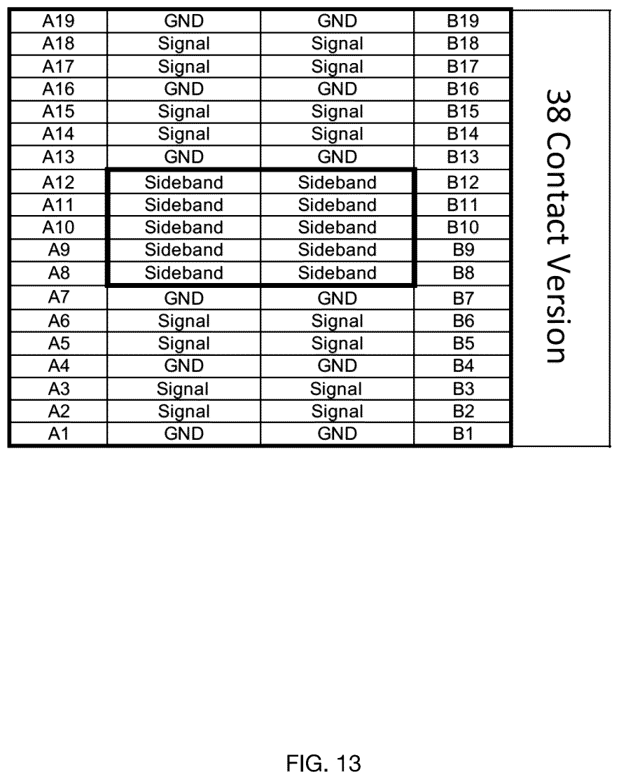

Referring briefly to FIG. 13, the pinout of a 38-contact MCIO cable is shown, from which it can be seen that a five-pin five-wire sideband channel is provided within the MCIO cable itself. This sideband channel can be used to transmit sideband information using a protocol such as I²C. Embodiments of this disclosure make use of a sideband channel within cable 700, if available, to transport telemetry over the cable. In this manner, CTRL can obtain telemetry corresponding to measurements made at the end of cable 700 that is remote from the first rack 605 and/or within the second rack 610 itself. In this case, retimers 705a and 705b can be configured to communicate telemetry between themselves using the sideband channel.

Thus, if CTRL requests telemetry from retimer 705a, retimer 705a can handle this request by: gathering first telemetry directly, requesting second telemetry from retimer 705b via the sideband channel, and subsequently transmitting both the first telemetry gathered directly by retimer 705a and also the second telemetry received from retimer 705b to CTRL. In this way, CTRL can obtain accurate telemetry for the entire length of the link involving retimers 705a and 705b. As retimers 705a and 705b can include a logical-level telemetry gathering circuit (e.g. a logic analyzer), the first telemetry and second telemetry can include logical-level telemetry as well as physical-level telemetry.

In cases where cable 700 does not have a sideband channel, an in-band channel can be used instead to transport telemetry between retimers 705a and 705b, i.e., across the cable 700. Similarly, in cases where the CTRL does not have a sideband channel to retimer 705a, an in-band channel may be utilized to transport telemetry data between retimer 705a and CTRL. In the case where the protocol being used to transport data across cable 700 is a PCIe protocol, a vendor-defined portion of a control skip-ordered set (C-SKP) as defined in the PCIe specification can be used to provide an in-band channel for transportation of telemetry between retimers 705a and 705b. More information on this is provided below in connection with FIGS. 8A and 8B.

FIG. 8A shows a decoded PCIe data stream 800 comprising multiple blocks. In FIG. 8A, a 128b130b encoding scheme is used, but this is not limiting as alternative encoding schemes could be used instead. For example, C-SKP ordered sets are used in PCIe Generation 6, which is FLITs-based and does not use 128b130b encoding. Data stream 800 is output by a physical coding sublayer receiver of a retimer like retimer 705a, 705b and is provided to a symbol decoder for detection of at least vendor-defined instructions. Each lane in a PCIe link has a respective data stream like data stream 800.

Block 805 is shown in detail as an illustrative example. Each block is bounded by block boundaries 810a, 810b. In this case as 128b 130b encoding is used, block 805 is 136 bytes long (including all headers) or 130 bytes long (excluding all zeroed headers). Each column of FIG. 8A is a 34-bit data word (including headers, 32-bit data word excluding headers). Other block lengths and data word sizes can alternatively be used.

Block 805 is shown divided up into a plurality of symbols 815, in this case 16 symbols. Each symbol in this case is 8 bits (one byte), but other symbol sizes can be used. More information on the symbols used is given below.

Also present are sync header bits 820, in this case comprising two bits. Other sized sync headers can alternatively be used. The sync header 820 marks the start of block 805 and hence the symbols shown in FIG. 8A are in the order in data stream 800 given by reading bottom to top, left to right, starting with sync header 820. The final symbol at the end of the block is a vendor-defined (‘VD’) symbol located in the top right corner of block 805. An exemplary value for the sync header is ‘10’ (binary), although alternative values could be used. The value of the sync header 820 is used to distinguish blocks like 805 that contain control information from data blocks (not shown) that contain data. A data block has a different value for the sync header that marks the start of the data block, e.g. ‘01’ (binary).

As the sync header marks the start of block 805, the header of each subsequent data word within block 805 is set to a value that clearly distinguishes it from sync header 820. In this case the header of each subsequent data word within block 805 is set to a zero value, i.e. ‘00’ in this two-bit example. Other values can alternatively be used.

The symbols shown in FIG. 8A are known generally in the art and so are not discussed in detail here. Of relevance to this discussion is C-SKP, which is a control skip symbol. This symbol also includes a value or set of values that is readily identifiable and that is distinguishable from the skip symbol, e.g. ‘78’ (hexadecimal) or alternating patterns of ‘F0h’ and ‘0Fh’ in the case of 1blb encoding (PCIe gen 6). Other values for the control skip symbol could alternatively be used. The presence of the control skip symbol signifies that block 805 is a ‘control skip ordered-set’, the significance of which here is that block 805 contains at least one VD block in which custom data can commands can be inserted.

‘VD’ in FIG. 8A is a byte storing a VD instruction or a part thereof, or custom data such as telemetry. The value of a VD byte is selected according to a VD scheme that defines the VD instruction that the VD byte is part of. Thus, in practice a VD byte can take any value as it will depend upon the VD instruction as defined by the VD scheme.

The third symbol in the final word of FIG. 8A (byte 14) is a composite symbol, formed of five bits relating to lane margining (‘LMR’) and three vendor-defined bits (VD). Specifically, bits [2:0] can be vendor-defined and bits [7:3] relate to lane margining. The effect of this that is relevant to this discussion is that a maximum of three bits of byte 14 can be used for conveying a VD instruction. Nevertheless, byte 14 of FIG. 8A should be understood to be a ‘VD byte’ as discussed above because a portion of byte 14 (0.375 of a byte) can be used to store a VD instruction or part thereof, or telemetry data. Other encoding schemes in which this entire byte is available for conveying a VD instruction are also possible.

In the case of FIG. 8, 1.375 VD bytes are present per block. This gives a maximum information carrying capacity of 1.375 bytes per block for a VD scheme. Telemetry data is typically of the order of one or a few bytes, and hence transportation using C-SKPs as described above is readily possible.

VD schemes that require more than 1.375 bytes to convey a VD instruction are also possible, as in this case a single VD instruction can be spread out over multiple control skip ordered-sets that are each like block 805. For example, a 4-byte VD instruction could be sent using three control skip ordered-sets in three distinct blocks. The three blocks could be sent via the same lane as each other, but at different times, or the blocks could be sent at the same time as each other via respective lanes. It is also possible to transmit a data package, such as retimer firmware, using the VD bytes, where many control skip-ordered sets are used to send the updated firmware to the retimer.

The LMR bits can also be used to transport telemetry. These bits can transport lane margining data, this being a measure of the electrical margin on a lane. The electrical margin is determined by measuring eye width and eye height and can thus constitute telemetry.

In some embodiments the LMR bits are not used to transport electrical margin information but instead some other telemetry, overriding their specified use and enabling 2 bytes per C-SKP_to be used to transport telemetry. To enable this, a custom protocol can be defined for use with C-SKPs, as discussed below.

Referring to FIG. 8B, two data streams are shown that provide an exemplary protocol that can be used to request telemetry data and respond with the requested telemetry data using C-SKPs as an in-band channel. These data streams are PCS-decoded in the case of PCIe Gen 4 or Gen 5 (128b130b decoded), or is raw in the case of PCIe Gen 6 as in this case no physical-layer encoding is performed. The data stream includes multiple C-SKP_blocks of the type shown in FIG. 8A, with each block including at least one VD byte. In some embodiments one VD byte is made use of, and in others the LMR bits are overridden to provide two VD bytes per C-SKP.

The left-hand side of FIG. 8B shows one possible set of C-SKPs sent in the downstream direction, e.g. from retimer 705a to retimer 705b via cable 700 (FIG. 7). This set of C-SKPs allows a request for telemetry to be made by retimer 705a and thus can be referred to as a telemetry request sequence. The telemetry request sequence is detected by retimer 705b and in response telemetry is returned using the sequence of C-SKPs shown on the right-hand side of FIG. 8B. This second sequence of C-SKPs can be referred to as a telemetry response sequence. The telemetry response sequence is sent in the upstream direction, i.e., from retimer 705b to retimer 705a via cable 700 (FIG. 7). The directions ‘upstream’ and ‘downstream’ can be reversed without departing from the teaching provided herein.

Other data is transmitted between adjacent C-SKPs and this is illustrated in FIG. 8B by dashed boxes labelled ‘data’. This is used as a convenient shorthand as in practice many bytes are transmitted between adjacent C-SKPs, including PCIe data and other control symbols that are sent in the PCIe L0 state, such as a SKP ordered set.

To initiate a telemetry request, a start C-SKP, C-SKP_0, is transmitted. C-SKP_0 is referred to as a ‘start C-SKP’ as it indicates to retimer 705b that a telemetry request is incoming. That is, detection of C-SKP_0 by retimer 705b causes retimer 705b to expect further details of a telemetry request to be incoming in subsequent C-SKPs.

An address C-SKP, C-SKP_1, may follow the start C-SKP_0. In the illustrated embodiment the C-SKP_1 is the next C-SKP_transmitted over the PCIe link, but this is not limiting as one or more C-SKPs or other control signals (e.g. a skip ordered-set, SKP) can be transmitted over the link between C-SKP_0 and C-SKP_1. The address C-SKP_can be omitted in cases where it is not needed, such as a link that includes just one retimer like retimer 705b.

Address C-SKP_1 specifies an address of retimer 705b. This allows retimer 705b to be sure that it is the intended recipient of the telemetry request. This can be useful in situations where multiple retimers of the same manufacture, e.g. two retimers, three retimers, four retimers or more are in a single link, as use of the address C-SKP_1 enables one of the multiple retimers to be targeted for a particular telemetry request. Any address format can be used so long as it is reliably identifiable by retimer 705b. The address C-SKP_can be omitted in cases where there is only one possible recipient of the telemetry request such that addressing is not required.

In the illustrated embodiment the address fits within one byte, such that a single C-SKP symbol can carry the entire address. This is not a limitation of the scope of this disclosure, however, as addresses of more than one byte in size can be used and carried by a corresponding number of C-SKP_symbols. For example, a 2-byte PCIe ‘Device Bus Function’ (D/B/F) address format can be used—in this case, two C-SKP_symbols may be needed to carry the address, with a respective byte of the address being carried by each C-SKP_symbol.

Retimers 705a, 705b can be assigned an address by writing the address to a respective address register (not shown) located on each retimer. In some cases the address is static and is written during manufacture. This is suited to a scenario in which details of the system in which the retimer is to be deployed are known in advance. In other cases the address is dynamically assigned in a configuration or startup phase, e.g. during a PCIe enumeration process. The address can be assigned by a root complex or by a CPU core of the retimer, for example. This is suited to a scenario in which details of the system in which the retimer is to be deployed are not known in advance. The retimer can compare an address received in one or more address C-SKP_symbols with the address stored in the address register. In the case of a match, the retimer continues processing the incoming symbols relating to the in-band telemetry request/response. In the case of no match, the retimer ignores additional incoming symbols relating to the telemetry request/response other than if another start C-SKP_is received. This is because another start C-SKP_signals that a new telemetry request/response is incoming, so the retimer is configured to check whether this new request/response is addressed to it.

A telemetry ID C-SKP, C-SKP_3, is also included in the telemetry request sequence. This follows the Start C-SKP_and, if present, the address C-SKP_also. The telemetry ID C-SKP includes an identifier that corresponds to a particular type of telemetry that is being requested. This could be, for example, an address of a register on retimer 705b where the telemetry is stored. Alternatively, each retimer can be in possession of a look up table or other such reference that assigns a respective telemetry ID to all possible types of telemetry that can be requested. In this case, the telemetry ID can be one or more bits that have been assigned to the specific telemetry data that is being requested, with the recipient retimer (e.g. retimer 705b) using its own look up table or equivalent to determine which telemetry data to return in response. Telemetry IDs that are larger than one byte can be carried by multiple telemetry ID C-SKPs, if necessary.

The telemetry request sequence can be terminated with a stop C-SKP, C-SKP_3. The stop C-SKP_signals to retimer 705b that the telemetry request sequence has been transmitted in its entirety. Retimer 705b can be configured to respond to a telemetry request sequence once the stop C-SKP of said sequence has been received.

Referring now to the right-hand side of FIG. 8B, a telemetry response sequence is shown. The telemetry response sequence can be transmitted by retimer 705b in an upstream direction to retimer 705a via cable 700, in response to a telemetry request sequence as described above.

The telemetry response sequence begins with a start C-SKP, C-SKP_0. This is the same as the start C-SKP of the telemetry request sequence and thus reference is made to the discussion above.

Following the start C-SKP_can be an address C-SKP, C-SKP_1. This is the same as the address C-SKP of the telemetry request sequence and thus reference is made to the discussion above. As in the case of the telemetry request sequence, the address C-SKP_is not required in the telemetry response sequence in the case where there is no ambiguity as to the recipient retimer for the telemetry response. This will depend on the specific configuration in which retimers 705a and 705b are deployed.

Following the start C-SKP or address C-SKP_if used, a size C-SKP, C-SKP_2, can be present. If present, the size C-SKP_specifies the total size of the telemetry data that is to follow, including any error-correcting bits like a CRC or parity bit(s) that may be included with the telemetry data. Multiple size C-SKPs can be used in the case where the total size of the telemetry data requires more than one C-SKP_to represent it. The size C-SKP_can be omitted in the case where the telemetry data is one or two bytes in size, as in that case just one C-SKP can be used to transport the entirety of the telemetry data. Alternatively, the size C-SKP_can be omitted irrespective of the size of the telemetry data on the understanding that the recipient retimer (e.g. 705a) assumes that all C-SKPs between the start or address C-SKP_and the stop C-SKP (see below) contain telemetry data.

Following whichever combination of the above-discussed C-SKPs is present, are one or more telemetry C-SKPs, C-SKP_4 to C-SKP_N. Each telemetry C-SKP_carries one or two bytes of telemetry data. The number of telemetry C-SKPs will thus depend directly on the size of telemetry data that is to be transmitted. It is expected that in most cases telemetry data will be one byte in size and therefore it is expected that just one telemetry C-SKP_will be needed in most cases. However, embodiments support arbitrarily-sized telemetry data by allowing for any number of telemetry C-SKPs to be transmitted.

The telemetry response sequence end with a stop C-SKP, C-SKP_N+1. This is the same as the stop C-SKP of the telemetry request sequence and thus reference is made to the discussion above.

Upon receipt of a stop C-SKP in the telemetry response sequence, retimer 705a has now obtained the requested telemetry. Retimer 705a can be configured to send the telemetry that it has received to another entity such as BMC_1, e.g. via sideband connection 710a.

As C-SKP_symbols are transmitted as part of a PCIe link in the L0 state, embodiments using C-SKP_symbols to transport a data package in-band do not disrupt or modify the normal traffic flow of an established PCIe link operating in the L0 state. Additionally, as components downstream of retimer 705b (e.g. EP) and upstream of retimer 705a (e.g. RC) will simply ignore the in-band messages and data contained with the C-SKP_symbols, retimers 705a, 705b does not need to adjust the retiming operations and can retime and forward the C-SKP_symbols in the same manner as with any other traffic received in the L0 state.

One or both of retimers 705a, 705b can include a logical-level telemetry gathering circuit such as a logic analyzer. If present, this enables logical-level telemetry to be captured and reported to a BMC. The logical-level telemetry, such as a RTSSM state, can be transported via C-SKPs as discussed above.

It is possible to include one or more check C-SKPs that allow error detection to be performed. If used, the one or more check C-SKPs can be sent prior to the stop C-SKP. The check C-SKPs can hold one or more parity bits, a cyclic redundancy check (CRC) code, or similar. The check C-SKPs can protect the telemetry sent in the one or more telemetry C-SKPs so that retimer 705a can detect any transmission errors in the telemetry. In the case where an error is detected, retimer 705a can send another telemetry request sequence re-requesting the corrupted telemetry.

Referring collectively to FIGS. 7, 8A and 8B, one way in which telemetry can be obtained is as follows.

The RC periodically transmits C-SKPs per the requirements of the PCIe protocol. These C-SKPs contain lane margining (LMR) commands. Each LMR command includes three bits to indicate a command type. One command type is a ‘register access’ command that enables a register on EP to be accessed. Another command type is ‘vendor defined’ indicating that the command is custom to the particular vendor. A further command type is ‘No Command’ indicating that no command is being transmitted with the corresponding C-SKP.

Retimer 705a can be configured to receive a telemetry request instruction from CTRL via sideband channel 710a. Upon receipt of this telemetry request instruction, retimer 705a can enter a snoop mode in which it monitors traffic that it receives from the RC to identify a C-SKP. When retimer 705a identifies a C-SKP, it can determine whether the command type is ‘No Command’. If the command type is ‘No Command’ then the RC is not expecting to receive a response to this C-SKP_and hence retimer 705a can safely overwrite this command type with a telemetry request command, e.g. a telemetry ID C-SKP_as discussed above. Retimer 705a thus generates a modified C-SKP (relative to the original C-SKP_generated by the RC) and transmits this modified C-SKP_to retimer 705b.

Retimer 705b can be configured to receive the telemetry request command in the modified C-SKP_and to act on it. Retimer 705b can also be configured to revert the modified C-SKP_to its original form, i.e. to remove the telemetry request command and replace it with a No Command. This means that the EP downstream from retimer 705b does not receive a C-SKP with a command within in that it does not know how to handle, such that the handling of the C-SKP_by the EP will be predictable.

A similar scheme can be employed in the reverse direction. When the EP transmits a ‘No Command’ C-SKP, this can be detected by retimer 705b and the content of the ‘No Command’ C-SKP_can be overwritten by telemetry data. Retimer 705a can be configured to extract the telemetry and to revert the C-SKP_to a ‘No Command’ C-SKP_by overwriting the telemetry with a ‘No Command’ instruction such that the RC handles the C-SKP in a predictable way.

This principle can be extended to the telemetry request sequence and telemetry response sequence as described above by identifying a series of ‘No Command’ C-SKPs in the upstream or downstream direction and modifying the instruction of each as discussed above.

Retimer 705b can be configured to act on a C-SKP_containing command information, e.g. a telemetry request C-SKP or a LMR command, in the following manner. Upon detection of such a C-SKP, retimer 705b raises an interrupt request (IRQ) that is handled by a local CPU or microcontroller that is part of retimer 705b. The IRQ causes the retimer CPU to trigger collection of the telemetry as required, and once this is ready the CPU sets a flag that instructs the retimer core to transmit the telemetry via the next available C-SKP(s).

It is possible to configure retimer 705b to interpret a standard LMR command in a non-standard way. Specifically, instead of responding with LMR data in response to an LMR command, retimer 705b can be configured to respond with any type of telemetry data, i.e. any physical telemetry or logical telemetry. Retimer 705b can be preconfigured to determine which telemetry data to provide, e.g. always responding with temperature data instead of LMR data. Alternatively, a telemetry ID C-SKP_can be sent prior to the LMR command such that retimer 705b responds with telemetry corresponding to that specified in the telemetry ID C-SKP.

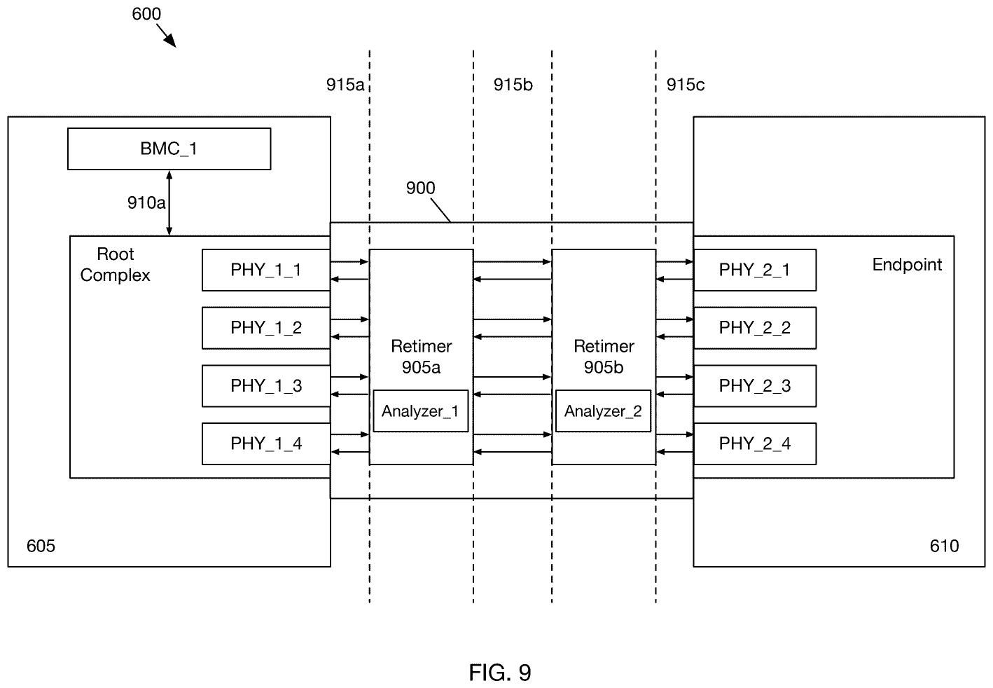

In another embodiment as shown in FIG. 9, the cables interconnecting the server racks are active cables. An active cable may include retimer devices 905a, 905b in each end of the active cable to extend the signal path between two devices operating in e.g., a PCIe link. In some embodiments, the BMC on one server in a server rack may monitor the link health status by gathering telemetry information about each device participating in the link as well as any retimer hops in the link. Embodiments are described herein for an active cable containing retimer circuit dies that include logic analyzers to gather telemetry information, and may provide such telemetry information about circuit dies on two different boards to a BMC on one of the boards.

FIG. 9 is a block diagram of two devices RC and EP on separate boards interconnected via an active cable 900. As shown, a four lane PCIe link is established between the two devices, however neither the number of lanes of such a link nor the protocol used should be considered limiting. Also as shown, each retimer 905a, 905b includes a logical-level telemetry gathering circuit in the form of a logic analyzer, although this can be omitted if desired. Each of retimers 905a and 905b can be of the type discussed in any of the preceding embodiments.

The logic analyzer may be configurable to analyze the PHYs of the retimer; both in the upstream and downstream direction. In some embodiments, the PHY circuit may include a processor for configuring and managing the physical layer transceivers, and for performing signal measurements, including eye diagram measurements (eye height, eye width, etc). In some embodiments, the logic analyzer may be configured to perform measurements on one lane at a time. In some embodiments, the logic analyzer may be configured to aggregate measurements of a plurality of lanes. In alternative embodiments, the logic analyzer may be configured to make e.g., eye measurements of the data received at the PHYs of the retimer circuit die. The logic analyzer or retimer processor may be configured to make bit-error rate measurements of the PCIe link. The logic analyzer may be configured to read and output state information of retimer training and status state machines (RTSSMs) configured to manage the core logic of the retimers.

In the embodiment of FIG. 9, it may be desired to provide the information gathered by logic analyzer ‘analyzer_2’ in retimer 905b to the BMC_1, which does not have a direct connection via SMBus to retimer 905b. In some embodiments, retimer 905a and retimer 905b may communicate with each other in-band using vendor defined messages in control skip ordered sets as discussed above in connection with FIGS. 7, 8A and 8B. In such an embodiment, retimer 805a may request telemetry information from retimer 905b via an in-band message, and retimer 905b may respond with the requested data to retimer 905a, which may then provide the data to BMC_1 on the first board 605.

### Retimer Module for Interconnecting Passive Cables

Active cables may be used between devices within a given chassis of a server rack, however active cables are not suited for all circumstances. For example, space and power dissipation may continue to be problematic. Further, as the cable length varies between applications and physical configurations of server devices, different length cables are required. Thus, the number of different active cables may grow large, and inventory and product SKU management becomes burdensome. Lastly, adding rigidity to the cable connector restricts overall cable flexibility and may present airflow and heat dissipation issues. Thus, while active cables do have utility in some scenarios, there are others where a passive cable is preferred.

Embodiments are described herein for a retimer module solution that interfaces between two passive MCIO cables to provide retimer functionalities. In some embodiments, the retimer module provides two connectors, one upstream and one downstream, for accepting passive cables to respective upstream and downstream devices. In alternative embodiments, the retimer may be configured to have at least one side, such as the upstream data communication side, hard wired to a fixed cable of a given length terminating in a connector, while the other side of the data connection, e.g., the downstream direction towards an endpoint, may be accessible via connector, such as an MCIO connector, adapted to receive a passive cable. In a further embodiment, the retimer module may be hardwired connected to two fixed passive cables on either side, with each cable having a respective connector for connection to the respective first and second boards. The various embodiments are all characterized by having only a single retimer placed in between the two cable ends, rather than having retimers at each end of an active cable. The retimer can be according to any of the retimer embodiments described herein.

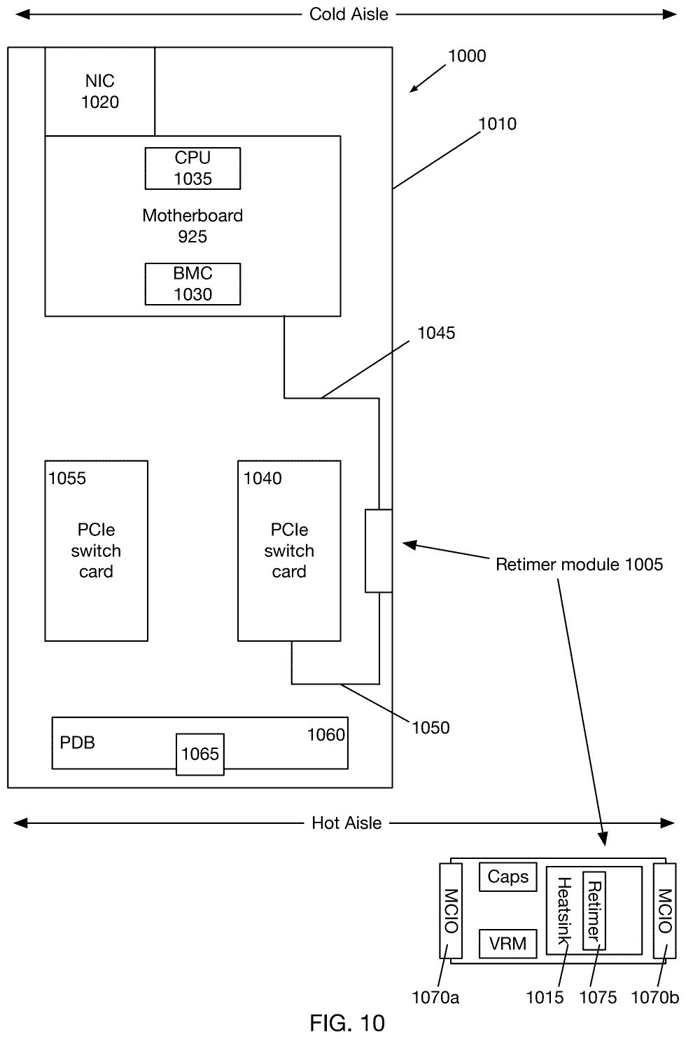

FIG. 10 is a top-down view of a server rack chassis 1000, illustrating placement of the retimer module 1005. As shown, the retimer module 1005 is attached to the chassis wall 1010 using a fastener (not shown), e.g., a snap connector or some other kind of fastener, including spring clips or retaining springs, which may be made of metal and exert pressure to hold the retimer module integrated circuit (IC) against the chassis-based heat sink 1015. A good thermal interface is created by ensuring firm contact between the IC and the heat sink 1015. Thermal Interface Pads (TIPs) may be placed between the IC and the heat sink 1015. The TIPs are made of materials with good thermal conductivity and conform to the surfaces, filling any microscopic gaps to enhance heat transfer.

Server rack chassis 1000 can also house other components. In the illustrated embodiment a network interface card (NIC) 1020 is communicatively coupled to a motherboard 1025 that includes a BMC 1030 and a CPU 1035. A second board 1040 is also housed within chassis 1000, the second board 1040 including a PCIe switch card that includes one or more slots/couplings for a component such as a GPU. These components are all purely exemplary and can all be replaced with different components without departing from the scope of this disclosure.

Retimer module 1005 facilitates communication between components on motherboard 1025 and components on the second board 1040. Retimer 1005 is coupled to motherboard 1025 via a first cable 1045 and coupled to the second board 1040 via a second cable 1050. In the illustrated embodiment both cables are Mini Cool Edge (MCIO) cables but this is not limiting on the scope of this disclosure as any type of cable can be used instead. A link, e.g. a PCIe link, can be established between a component on the motherboard 1025, e.g., CPU 1035 and a component on the second board 1040, e.g., a GPU.

MCIO cables provide a sideband channel-see FIG. 13—and this sideband channel can be used to carry telemetry relating to the end of the link proximate the second board 1040 from the second board 1040 to the motherboard 1025, and specifically to BMC 1030. In the case of cables that do not include a sideband channel, in-band channel, e.g., of the type disclosed in [Roy] and discussed above, can be used to transport telemetry from the second board 1040 to the motherboard 1025. In each case, retimer 1075 that is part of retimer module 1005 can coordinate the collection and transmission of telemetry in the manner discussed above using the sideband or in-band channel. In both cases, it is thus possible for BMC 1030 to obtain telemetry relating to parts of the link that it does not have direct access to, e.g., via a SMBus or other such connection.

It is possible for chassis 1000 to include a third board 1055. In this case second cable 1050 can be a fan out cable that splits into two cables along its length, each of the cables having a respective connector. One of the connectors can be coupled to second board 1040 and the other connector coupled to third board 1055. The principles discussed above can be applied to each of the cables of second cable 1050 so as to enable telemetry to be reported from both second board 1040 and third board 1055 to BMC 1030. This technique can be extended to any number of boards on chassis 1000 by increasing the number of cables that fan out of second cable 1050.

Thus, with a single retimer module, data connections may be extended using a first passive cable from a first board or assembly to the centrally located retimer module, and a second passive cable from the retimer to the second board or assembly.

Also shown in FIG. 10 is a power distribution board (PDB) 1060 including a heatsink 1065. The PDB provides power to the various components within chassis 1000 via power distribution wires (not shown).

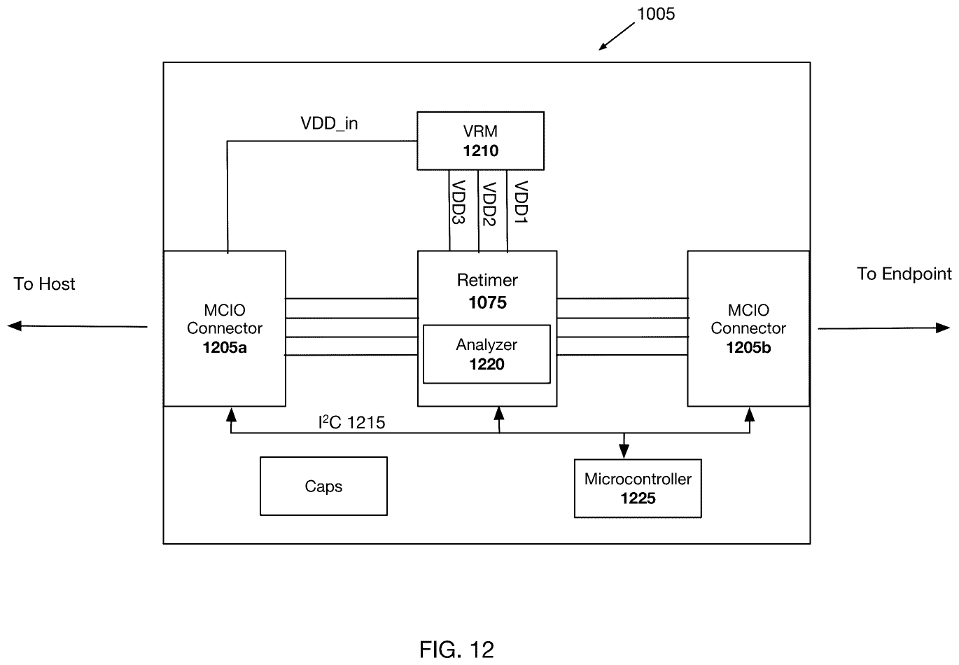

FIG. 10 shows retimer module 1005 in more detail in the bottom left of the figure. First and second connectors 1070a, 1070b, in this case MCIO connectors, are located at opposing ends of retimer module 1005 and provide a point of connection for first cable 1045 and second cable 1050, respectively. Retimer module 1005 also includes some capacitors (‘caps’) and a voltage regulator module (VRM). Further details about the VRM are provided below in connection with FIG. 12. Retimer logic 1075 is secured to heatsink 1015 and is configured to provide retiming functionality for signals received via the first and second connectors 1070a, 1070b. Retimer logic 1075 is also configured to relay telemetry received via a sideband channel or an in-band channel to BMC 1030 in the manner discussed above.

The retimer module 1005 has a low-profile to reduce air flow restriction. The total cable length between devices is customizable, as two stock cable lengths may be selected in different combinations, thus reducing the number of cable lengths needed to be stocked. The cable length may be customizable in the field. Depending on the available chassis area, multiple retimers may be mounted onto the chassis for multiple links operating at once. The retimer module may be placed on the sides of the server chassis in an area typically reserved for cabling, and may thus attach to the chassis wall or other internal components that may provide a heat sink for heat dissipation.

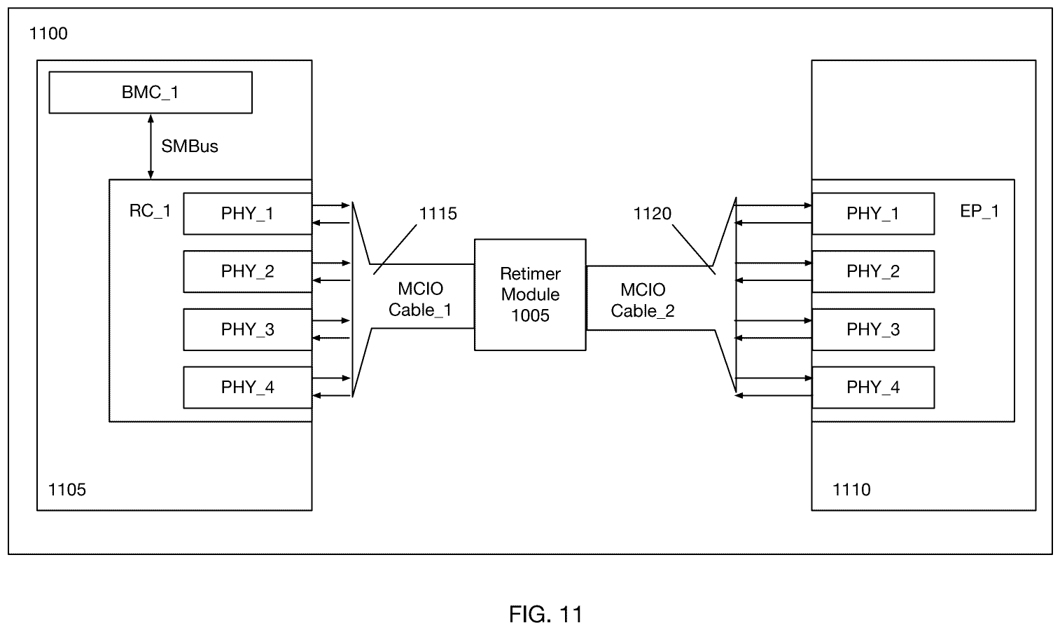

FIG. 11 is a block diagram of a server rack chassis 1100 containing two circuit boards 1105, 1110. This arrangement is similar to that disclosed in connection with FIG. 10. As shown, a PCIe link is established between a host device RC_1 and endpoint device EP_1. As shown, the devices are on separate boards 1105, 1110 interconnected by MCIO cables 1115, 1120. In some embodiments, the host may be a CPU. In some embodiments, the endpoint device may be a GPU, SSD, or PCIe switch. Retimer module 1005 is interposed between the two MCIO cables. The retimer module 1005 improves the SI of the PCIe link and may extend the length of the channel. Telemetry can be transmitted via MCIO cables 1115, 1120 from circuit board 1110 to circuit board 1105, with retimer 1005 facilitating transmission of the telemetry either via a sideband channel (e.g., I²C) or an in-band channel (e.g., vendor-defined messages) as discussed above.

FIG. 12 is a block diagram of retimer module 1005, in accordance with some embodiments. As shown, the retimer module includes MCIO connectors 1205a/1205b. The retimer module can further comprise a voltage regulator module (VRM) 1210 configured to receive a supply voltage from the MCIO connector 1205b or 1205b transferred via the MCIO cable. The supply voltage may be received on e.g., one of the sideband pins shown in FIG. 13. The VRM is configured to supply the retimer 1075 with a plurality of regulated supply voltages for e.g., analog circuitry and digital circuitry components. The VRM can be omitted in cases where the voltage supplied by the cable is sufficient for all of the operations of the retimer.

The retimer module 1005 further includes an I²C interface 1215, which may also be interconnected between the host and endpoint using the sideband channels of the MCIO interface. The retimer module 1005 further includes a retimer 1075 as described above. In some embodiments, the retimer 1075 may be a single circuit die. In some embodiments, the retimer 1027 may include a plurality of homogenous retimer circuit dies.

As shown, retimer 975 further includes a logic analyzer 1120 configured to monitor health of the passive cable and to provide telemetry information via the I²C bus 1115 back to the host. The I²C interface on the retimer 1075 may be further utilized for e.g., lane routing configuration. The retimer module 1005 may further pass through transactions between the host and endpoint devices on the I²C interface.

In some embodiments, the retimer module 1005 further includes a microcontroller 1225. Microcontroller 1225 may be configured to manage the I²C interface to a plurality of downstream devices. Such an application may be e.g., an SSD storage server containing up to as many as 24 individual SSDs. In this case, the cable coupled between retimer module 1005 and the SSD storage server can be a fan out cable with a number of branches corresponding to the number of individual SSDs.

The retimer 1075 includes one or more PHYs of an upstream pseudo-port (see FIGS. 2 and 3) that interface to MCIO connector 1205a. Retimer 1075 further includes one or more PHYs of a downstream pseudo-port that interface to MCIO connector 1205b. FIG. 12 illustrates a ×4 lane link, however such a width should not be considered limiting. Depending on the total number of PHYs, the retimer 1075 may be configured to support a PCIe link having any amount of lanes, including but not limited to ×1, ×2, ×4, ×8, and ×16 lane wide links.

In some embodiments, the retimer module 1005 may support a plurality of PCIe links simultaneously to different endpoints. For example, in one embodiment, retimer 1075 includes 8 total PHYs, and the retimer 1075 may support the following configurations:
Four ×1 lane links
One ×2 lane link and two ×1 lane links
Two ×2 lane links
One ×4 lane link

In some embodiments, the retimer 1075 may be housed in a package. In some embodiments, other components shown on the retimer module may be included in the package. E.g., the VRM may be included in the package. In alternative embodiments, the retimer 1075 may be implemented using a bare die packaging method to reduce the overall are occupied by retimer 1075. As shown in FIG. 10, the retimer 1075 may be mounted on a heat sink (see FIG. 9).

FIG. 13 is an illustration of a pinout of the MCIO interface. As shown, the MCIO interface includes a plurality of signal pins, a plurality of ground pins, and a plurality of sideband pins. In some embodiments, the signal pins are mapped via the I²C interface depending on a lane configuration for the PCIe link. As described above, the sideband pins may be utilized to provide the supply voltage (e.g., 12V or 3.3V) to the VRM. Further, the sideband pins may be used to communicate I²C.

It will be apparent to a person skilled in the art having the benefit of the present disclosure that various modifications, extensions, substitutions and the like to the subject matter described herein are possible. Such changes are also within the scope of this disclosure. It is also noted that, where method steps are described, these steps can be performed in any order unless expressly stated otherwise.

1. A method comprising:
receiving, at an upstream-facing pseudo-port of a retimer, a telemetry request command via one or more control skip-ordered sets (C-SKPs), the telemetry request command including one of a plurality of telemetry IDs respectively identifying types of telemetry data, the types of telemetry data selected from the group consisting of: retimer training and status state machine (RTSSM) state information and temperature data;
retrieving telemetry data from the retimer associated with the telemetry ID in the telemetry request command;
receiving C-SKPs at a downstream-facing pseudo-port of the retimer, and responsively generating modified C-SKPs by rewriting fields of the received C-SKPs with the retrieved telemetry data; and
transmitting the modified C-SKPs via the upstream-facing pseudo-port.

2. The method of claim 1, wherein the RTSSM state information comprises state history information associated with a plurality of synchronized RTSSMs in a plurality of homogenous circuit dies of the retimer.

3. The method of claim 2, wherein the state history information is lane-specific for a plurality of lanes in one or more of the upstream-facing pseudo-port and downstream-facing pseudo-port.

4. The method of claim 2, further comprising gathering the RTSSM state information using a logic analyzer.

5. The method of claim 1, further comprising modifying the C-SKPs received at the upstream-facing pseudo-port into no-command C-SKPs, and transmitting the no-command C-SKPs via the downstream-facing pseudo-port.

6. The method of claim 1, wherein the one or more C-SKPs of the telemetry request command comprises a C-SKP_containing an address identifying the retimer.

7. The method of claim 1, wherein generating the modified C-SKPs further comprises rewriting the fields of at least one received C-SKP_with a value identifying a size of the retrieved telemetry data.

8. The method of claim 1, wherein the C-SKPs received at the downstream-facing pseudo-port are no-command C-SKPs.

9. The method of claim 1, wherein the downstream-facing pseudo-port has a peripheral component interface express (PCIe) interface to a second retimer.

10. The method of claim 9, further comprising receiving C-SKPs of a telemetry response from the second retimer and transmitting the received C-SKPs of the telemetry response via the upstream-facing pseudo-port.

11. An apparatus comprising:
An upstream-facing pseudo-port of a retimer configured to receive a telemetry request command via one or more control skip-ordered sets (C-SKPs) received over a first peripheral component interface express (PCIe) link, the telemetry request command including one of a plurality of telemetry IDs respectively identifying types of telemetry data, the types of telemetry data selected from the group consisting of: retimer training and status state machine (RTSSM) state information and temperature data, the upstream-facing pseudo-port further configured to transmit modified C-SKPs containing telemetry data;
a downstream-facing pseudo-port of the retimer configured to receive C-SKPs via a second PCIe link; and
a telemetry gathering circuit configured to retrieve the telemetry data from the retimer associated with the telemetry ID in the telemetry request command, and to generate the modified C-SKPs by rewriting fields of the C-SKPs received via the second PCIe link with the retrieved telemetry data.

12. The apparatus of claim 11, wherein the RTSSM state information comprises state history information associated with a plurality of synchronized RTSSMs in a plurality of homogenous circuit dies of the retimer.

13. The apparatus of claim 12, wherein the state history information is lane-specific for a plurality of lanes in one or more of the upstream-facing pseudo-port and downstream-facing pseudo-port.

14. The apparatus of claim 12, wherein the telemetry gathering circuit comprises a logic analyzer configured to gather the RTSSM state information.

15. The apparatus of claim 11, wherein the telemetry gathering circuit is further configured to modify the C-SKPs received at the upstream-facing pseudo-port into no-command C-SKPs, and to provide the no-command C-SKPs to the downstream-facing pseudo-port for transmission.

16. The apparatus of claim 11, wherein the one or more C-SKPs of the telemetry request command comprises a C-SKP_containing an address identifying the retimer.

17. The apparatus of claim 11, wherein the telemetry gathering circuit is configured to generate the modified C-SKPs by rewriting the field of at least one received C-SKP_with a value identifying a size of the retrieved telemetry data.

18. The apparatus of claim 11, wherein the C-SKPs received at the downstream-facing pseudo-port are no-command C-SKPs.

19. The apparatus of claim 11, wherein the second PCIe link is connected to an upstream-facing pseudo-port of a second retimer.

20. The apparatus of claim 11, wherein the telemetry gathering circuit is configured to obtain a write pointer for C-SKPs received via the second PCIe link and stored in an elastic buffer in physical coding sublayer (PCS) layer logic in the retimer.
